(19) United States
(12) Patent Application Publication
(10) Pub. No.: US 2025/0343647 A1
(43) Pub. Date: Nov. 6, 2025

(54) NON-UNIFORM CODING FOR CSI REPORTING

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 19/176,744

(22) Filed: Apr. 11, 2025

Related U.S. Application Data
(60) Provisional application No. 63/641,781, filed on May 2, 2024.

(51) Int. Cl. H04L 5/00; H04W 72/21

(52) U.S. Cl. CPC H04L 5/0048; H04L 5/0053; H04W 72/21

(57) ABSTRACT

Apparatuses and methods for efficient reporting. A method performed by a user equipment (UE) includes receiving information about channel state information (CSI) and determining the coefficient values. The CSI includes coefficient values that are encoded based on a variable-length (VL) encoder {(νₖ, Aₖ)} where a coefficient value Aₖ is encoded as a VL code νₖ, k=0, . . . , N_{VL}−1, and N_{VL} is a number of VL codes. The method further includes determining VL codes of the coefficient values based on the VL encoder and transmitting a CSI report including at least one indicator indicating the VL codes of the coefficient values.

### CROSS-REFERENCE TO RELATED AND CLAIM OF PRIORITY

The present application claims priority under 35 U.S.C. § 119(e) to U.S. Provisional Patent Application No. 63/641,781 filed on May 2, 2024, which is hereby incorporated by reference in its entirety.

### TECHNICAL FIELD

The present disclosure relates generally to wireless communication systems and, more specifically, the present disclosure is related to apparatuses and methods for efficient reporting and non-uniform coding for channel state information (CSI) reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to efficient reporting and non-uniform coding for CSI reporting.

In one embodiment, a user equipment (UE) is provided. The UE includes a transceiver configured to receive information about CSI. The CSI including coefficient values that are encoded based on a variable-length (VL) encoder {(νₖ, Aₖ)} where a coefficient value Aₖ is encoded as a VL code νₖ, k=0, . . . , N_{VL}−1, and N_{VL} is a number of VL codes. The UE further includes a processor operably coupled to the transceiver. The processor is configured to determine the coefficient values and determine VL codes of the coefficient values based on the VL encoder. The transceiver is configured to transmit a CSI report including at least one indicator indicating the VL codes of the coefficient values.

In another embodiment, a base station (BS) is provided. The BS includes a processor and a transceiver operably coupled to the processor. The transceiver is configured to transmit information about CSI and receive a CSI report including at least one indicator indicating VL codes of the coefficient values. The CSI includes coefficient values that are encoded based on a VL encoder {(νₖ, Aₖ)} where a coefficient value Aₖ is encoded as a VL code νₖ, k=0, . . . , N_{VL}−1, and N_{VL} is a number of VL codes. The VL codes of the coefficient values are based on the VL encoder.

In yet another embodiment, a method performed by a UE is provided. The method includes receiving information about CSI and determining the coefficient values. The CSI includes coefficient values that are encoded based on a VL encoder {(νₖ, Aₖ)} where a coefficient value Aₖ is encoded as a VL code νₖ, k=0, . . . , N_{VL}−1, and N_{VL} is a number of VL codes. The method further includes determining VL codes of the coefficient values based on the VL encoder and transmitting a CSI report including at least one indicator indicating the VL codes of the coefficient values.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIG. 6 illustrates an example of a transmitter structure for physical downlink shared channel (PDSCH) in a subframe according to embodiments of the present disclosure;

FIG. 7 illustrates an example of a receiver structure for PDSCH in a subframe according to embodiments of the present disclosure;

FIG. 8 illustrates an example of a transmitter structure for physical uplink shared channel (PUSCH) in a subframe according to embodiments of the present disclosure;

FIG. 9 illustrates an example of a receiver structure for a PUSCH in a subframe according to embodiments of the present disclosure;

FIG. 10 illustrates a diagram of example radio access network (RAN) configurations according to embodiments of the present disclosure;

FIG. 11 illustrates an example of a fully digital transmitter structure for beamforming according to embodiments of the present disclosure;

FIG. 12 illustrates a diagram of example functional split points/options according to embodiments of the present disclosure;

FIG. 13 illustrates an example of download precoding schemes according to embodiments of the present disclosure;

FIG. 14 illustrates a signal flow and procedure diagram according to embodiments of the present disclosure;

FIG. 15 illustrates a diagram of an example precoding procedure according to embodiments of the present disclosure;

FIG. 16 illustrates a diagram of an example convolutional neural network (CNN) according to embodiments of the present disclosure;

FIG. 17 illustrates a diagram of an example antenna port layout according to embodiments of the present disclosure;

FIG. 18 illustrates a timeline of example spatial-domain (SD) units and frequency-domain (FD) units according to embodiments of the present disclosure;

FIG. 19 illustrates an example of codes of a variable length (VL) encoder according to embodiments of the present disclosure;

FIG. 20 illustrates an example of uplink control information according to embodiments of the present disclosure;

FIG. 21 illustrates a diagram of an example of a VL encoder based on a multi-level codebook according to embodiments of the present disclosure; and

FIG. 22 illustrates an example method performed by a UE in a wireless communication system according to embodiments of the present disclosure

### DETAILED DESCRIPTION

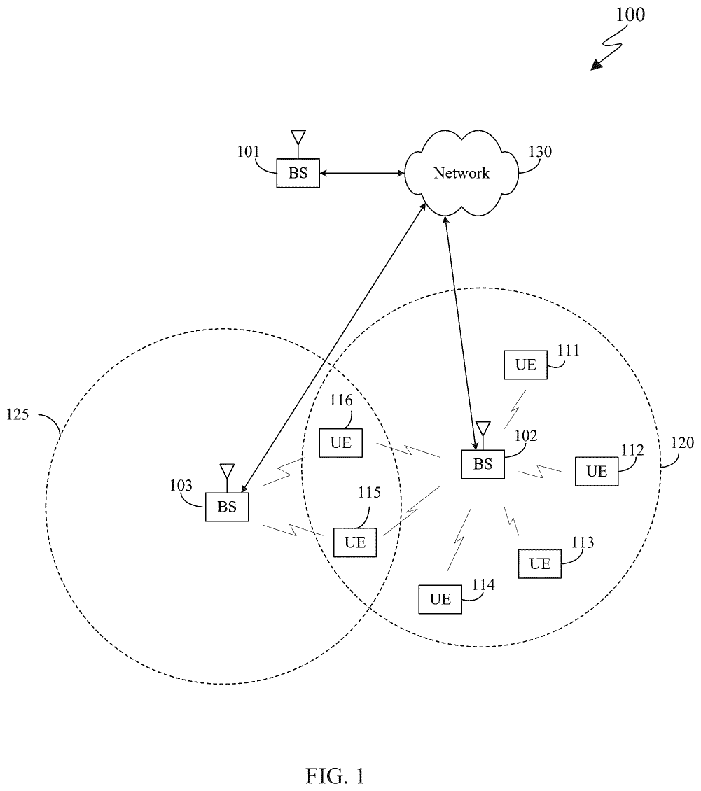

FIGS. 1-22 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

In the 5G system, Hybrid frequency shift keying (FSK) and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [REF 1]3GPP, TS 38.211, 5G; NR; Physical channels and modulation; [REF 2]3GPP, TS 38.331, 5G; NR; Radio Resource Control (RRC); Protocol specification; [REF 3]3GPP, TS 38.321, 5G; NR; Medium Access Control (MAC); Protocol specification; [REF 4]3GPP, TS 38.214, 5G; NR; Physical layer procedures for data; [REF 5] https://mathworld.wolfram.com/ToeplitzMatrix.html; [REF 6]M. Wax and T. Kailath, “Efficient inversion of a doubly block Toeplitz matrix”, in Proc. IEEE ICASSP, pp. 170-173, Apr. 14-16, 1983. [REF 7] https://mathworld.wolfram.com/CirculantMatrix.html; [REF 8]A. Araujo, “Building Compact and Robust Deep Neural Networks with Toeplitz Matrices”, https://arxiv.org/pdf/2109.00959.pdf; [REF 9]3GPP TS 38.212 v18.0.0, “E-UTRA, NR, Multiplexing and Channel coding”; [REF 10]3GPP TS 38.213 v18.0.0, “E-UTRA, NR, Physical Layer Procedures for Control”; [REF 11]O-RAN.WG4.CONF.0-R003-v09.00, “O-RAN Working Group 4 (Fronthaul Working Group) Conformance Test Specification”; [REF 12]O-RAN.WG4.CUS.0-R003-v13.00, “O-RAN Working Group 4 (Open Fronthaul Interfaces WG)—Control, User and Synchronization Plane Specification.

FIGS. 1-22 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for efficient reporting and non-uniform coding for CSI reporting. In certain embodiments, one or more of the BSs 101-103 include circuitry, programing, or a combination thereof to support efficient reporting and non-uniform coding for CSI reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

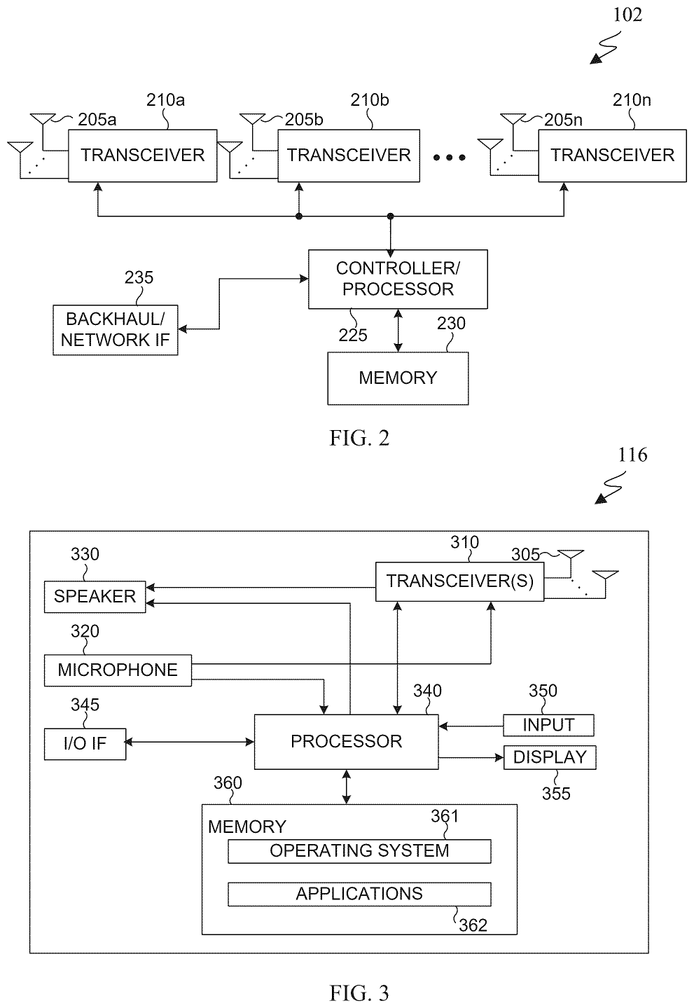

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for efficient reporting and non-uniform coding for CSI reporting. Any of a wide variety of other functions could be supported in the gNB 102 by the controller/processor 225.

The controller/processor 225 is also capable of executing programs and other processes resident in the memory 230, such as processes to support efficient reporting and non-uniform coding for CSI reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of uplink (UL) channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for efficient reporting and non-uniform coding for CSI reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

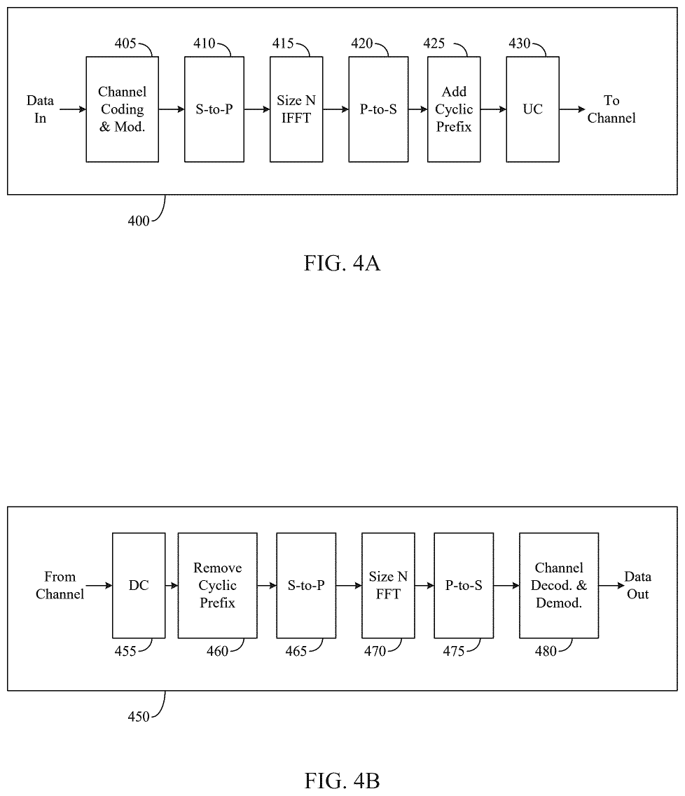

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or receive path 450 is configured for efficient reporting and non-uniform coding for CSI reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

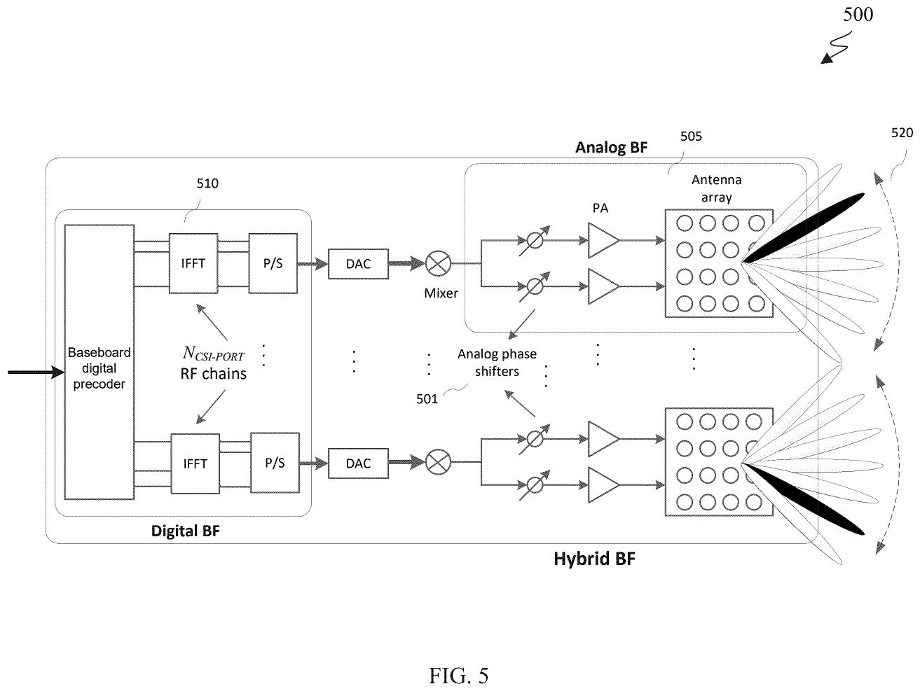

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

In a hybrid analog-digital beamforming, analog beamforming corresponds to a ‘dynamic/varying’ virtualization of multiple antenna elements to obtain one antenna port (or antenna panel). Although the number of antenna elements can be larger for a given form factor, the number of antenna ports—which can correspond to the number of digitally precoded ports—tends to be limited due to hardware constraints (such as the feasibility to install a large number of ADCs/DACs at mmWave frequencies) as illustrated in FIG. 5. In this case, one port is mapped onto a large number of antenna elements which can be controlled by a bank of analog phase shifters 501. One port can then correspond to one sub-array which produces a narrow analog beam through analog beamforming 505. This analog beam can be configured to sweep across a wider range of angles (520) by varying the phase shifter bank across symbols or subframes (or slots). The number of sub-arrays (equal to the number of RF chains) is the same as the number of antenna ports N_{PORT}. A digital beamforming unit 510 performs a linear combination across N_{PORT} analog beams to further increase precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam. Due to large propagation and O2 absorption loss at high frequencies, larger number of and sharper analog beams (hence larger number of radiators in the array) are needed to compensate for the additional path loss.

The present disclosure relates generally to wireless communication systems and, more specifically, to next generation of MIMO systems.

A communication system includes a DownLink (DL) that conveys signals from transmission points such as Base Stations (BSs) or NodeBs to User Equipments (UEs) and an UpLink (UL) that conveys signals from UEs to reception points such as NodeBs. A UE, also commonly referred to as a terminal or a mobile station, may be fixed or mobile and may be a cellular phone, a personal computer device, or an automated device. An eNodeB, which is generally a fixed station, may also be referred to as an access point or other equivalent terminology. For LTE systems, a NodeB is often referred as an eNodeB (eNB). For 5G NR systems, a NodeB is often referred as an gNodeB (gNB).

In a communication system, such as LTE, 5G NR, or a next-generation system (e.g., 6G), DL signals can include data signals conveying information content, control signals conveying DL Control Information (DCI), and Reference Signals (RS) that are also known as pilot signals. An eNB/gNB transmits data information through a Physical DL Shared CHannel (PDSCH). An eNB/gNB transmits DCI through a Physical DL Control CHannel (PDCCH). An eNB/gNB transmits one or more of multiple types of RS including a Channel State Information RS (CSI-RS), or a DeModulation RS (DMRS). An eNB/gNB may transmit a CSI-RS with a density in the time and/or frequency domain for the UE to perform channel measurements. DMRS can be transmitted only in the BW of a respective PDSCH and a UE can use the DMRS to demodulate data or control information in a PDSCH or a PDCCH, respectively. A transmission time interval for DL channels is referred to as a subframe or a slot, comprise multiple (e.g., 14) OFDM symbols, and can have, for example, a duration of x millisecond, where x may depend on the subcarrier spacing (SCS). For example, x=1 for SCS=15 kHz.

DL signals also include transmission of a logical channel that carries system control information. A BCCH is mapped to either a transport channel referred to as a Broadcast CHannel (BCH) when it conveys a Master Information Block (MIB) or to a DL Shared CHannel (DL-SCH) when it conveys a System Information Block (SIB). Most system information is included in different SIBs that are transmitted using DL-SCH. A presence of system information on a DL-SCH in a subframe (or slot) can be indicated by a transmission of a corresponding PDCCH conveying a codeword with a CRC scrambled with a special System Information RNTI (SI-RNTI). Alternatively, scheduling information for a SIB transmission can be provided in an earlier SIB and scheduling information for the first SIB (SIB-1) can be provided by the MIB.

DL resource allocation is performed in a unit of subframe (or slot) and a group of Physical resource blocks (PRBs). A transmission BW includes of frequency resource units referred to as Resource Blocks (RBs). Each RB includes of

$${N}_{sc}^{RB}$$

sub-carriers, or Resource Elements (REs), such as 12 REs. A unit of one RB over one subframe (or slot) is referred to as a PRB. A UE can be allocated M_{PDSCH} RBs for a total of

$${M}_{sc}^{PDSCH} = {M}_{PDSCH} \cdot {N}_{sc}^{RB}$$

REs for the PDSCH transmission BW.

UL signals can include data signals conveying data information, control signals conveying UL Control Information (UCI), and UL RS. UL RS includes DMRS and Sounding RS (SRS). A UE transmits DMRS only in a BW of a respective PUSCH or PUCCH. An eNodeB can use a DMRS to demodulate data signals or UCI signals. A UE transmits SRS to provide an eNodeB with an UL CSI. A UE transmits data information or UCI through a respective Physical UL Shared CHannel (PUSCH) or a Physical UL Control CHannel (PUCCH). If a UE needs to transmit data information and UCI in a same UL subframe (or slot), it may multiplex both in a PUSCH. UCI includes Hybrid Automatic Repeat reQuest ACKnowledgement (HARQ-ACK) information, indicating correct (ACK) or incorrect (NACK) detection for a data TB in a PDSCH or absence of a PDCCH detection (DTX), Scheduling Request (SR) indicating whether a UE has data in its buffer, Rank Indicator (RI), and Channel State Information (CSI) enabling an eNodeB to perform link adaptation for PDSCH transmissions to a UE. HARQ-ACK information is also transmitted by a UE in response to a detection of a PDCCH/EPDCCH indicating a release of semi-persistently scheduled PDSCH (see also REF 3).

An UL subframe (or slot) includes two slots. Each slot includes

$${N}_{symb}^{UL}$$

symbols for transmitting data information, UCI, DMRS, or SRS. A frequency resource unit of an UL system BW is an RB. A UE is allocated N_{RB} RBs for a total of

$${N}_{RB} \cdot {N}_{sc}^{RB}$$

REs for a transmission BW. For a PUCCH, N_{RB}=1. A last subframe (or slot) symbol can be used to multiplex SRS transmissions from one or more UEs. A number of subframe (or slot) symbols that are available for data/UCI/DMRS transmission is

$${N}_{symb} = 2 \cdot ( {N}_{symb}^{UL} - 1 ) - {N}_{SRS} ,$$

where N_{SRS}=1 if a last subframe (or slot) symbol is used to transmit SRS and N_{SRS}=0 otherwise.

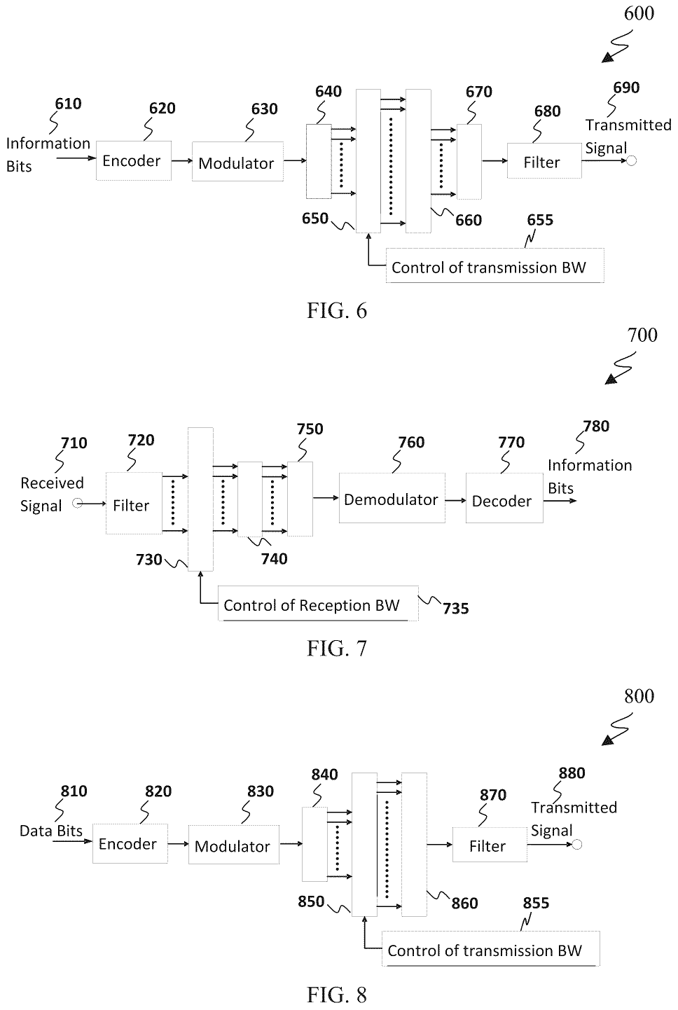

FIG. 6 illustrates an example of a transmitter structure 600 for PDSCH in a subframe according to embodiments of the present disclosure. For example, transmitter structure 600 can be implemented in gNB 102 of FIG. 1. This example is for illustration only and other embodiments can be used without departing from the scope of the present disclosure.

As illustrated in FIG. 6, information bits 610 are encoded by encoder 620, such as a turbo encoder, and modulated by modulator 630, for example using Quadrature Phase Shift Keying (QPSK) modulation. A Serial to Parallel (S/P) converter 640 generates M modulation symbols that are subsequently provided to a mapper 650 to be mapped to REs selected by a transmission BW selection unit 655 for an assigned PDSCH transmission BW, unit 660 applies an Inverse Fast Fourier Transform (IFFT), the output is then serialized by a Parallel to Serial (P/S) converter 670 to create a time domain signal, filtering is applied by filter 680, and a signal transmitted 690. Additional functionalities, such as data scrambling, cyclic prefix insertion, time windowing, interleaving, and others are well known in the art and are not shown for brevity.

FIG. 7 illustrates an example of a receiver structure 700 for PDSCH in a subframe according to embodiments of the present disclosure. For example, receiver structure 700 can be implemented by any of the UEs 111-116 of FIG. 1. This example is for illustration only and other embodiments can be used without departing from the scope of the present disclosure.

With reference to FIG. 7, a received signal 710 is filtered by filter 720, REs 730 for an assigned reception BW are selected by BW selector 735, unit 740 applies a Fast Fourier Transform (FFT), and an output is serialized by a parallel-to-serial converter 750. Subsequently, a demodulator 760 coherently demodulates data symbols by applying a channel estimate obtained from a DMRS or a CRS (not shown), and a decoder 770, such as a turbo decoder, decodes the demodulated data to provide an estimate of the information data bits 780. Additional functionalities such as time-windowing, cyclic prefix removal, de-scrambling, channel estimation, and de-interleaving are not shown for brevity.

FIG. 8 illustrates an example of a transmitter structure 800 for PUSCH in a subframe according to embodiments of the present disclosure. For example, transmitter structure 800 can be implemented in gNB 103 of FIG. 1. This example is for illustration only and other embodiments can be used without departing from the scope of the present disclosure.

As illustrated in FIG. 8, information data bits 810 are encoded by encoder 820, such as a turbo encoder, and modulated by modulator 830. A Discrete Fourier Transform (DFT) unit 840 applies a DFT on the modulated data bits, REs 850 corresponding to an assigned PUSCH transmission BW are selected by transmission BW selection unit 855, unit 860 applies an IFFT and, after a cyclic prefix insertion (not shown), filtering is applied by filter 870 and a signal transmitted 880.

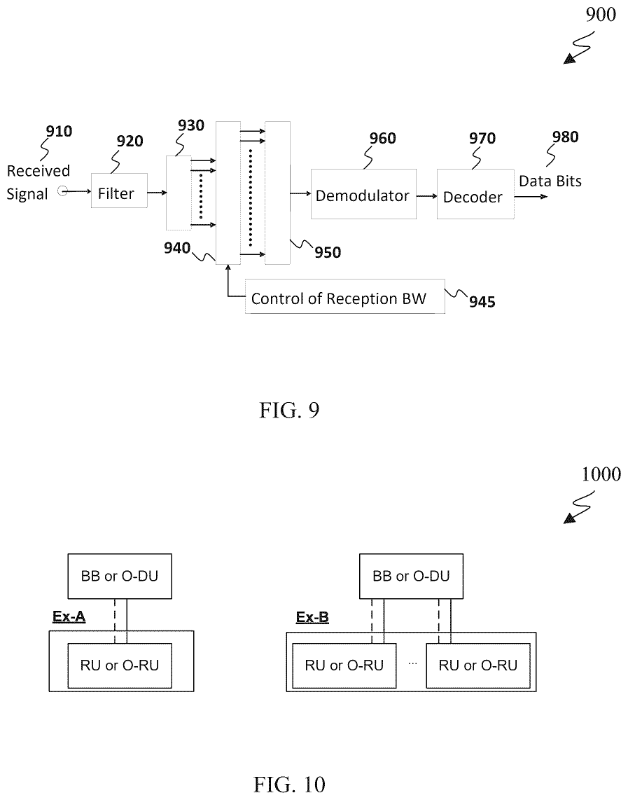

FIG. 9 illustrates an example of a receiver structure 900 for a PUSCH in a subframe according to embodiments of the present disclosure; For example, receiver structure 900 can be implemented by the UE 116 of FIG. 3. This example is for illustration only and other embodiments can be used without departing from the scope of the present disclosure.

As illustrated in FIG. 9, a received signal 910 is filtered by filter 920. Subsequently, after a cyclic prefix is removed (not shown), unit 930 applies an FFT, REs 940 corresponding to an assigned PUSCH reception BW are selected by a reception BW selector 945, unit 950 applies an Inverse DFT (IDFT), a demodulator 960 coherently demodulates data symbols by applying a channel estimate obtained from a DMRS (not shown), a decoder 970, such as a turbo decoder, decodes the demodulated data to provide an estimate of the information data bits 980.

There are two types of frequency range (FR) defined in 3GPP 5G NR specifications. The sub-6 GHz range is called frequency range 1 (FR1) and millimeter wave range is called frequency range 2 (FR2). An example of the frequency range for FR1 and FR2 is shown below in Table 1. Whenever the FR2 is referred, both FR2-1 and FR2-2 frequency sub-ranges shall be considered, unless otherwise stated.

TABLE 1
Definition of frequency ranges

| | |
|---|---|
| Frequency range designation | Corresponding frequency range |

| FR1 | | 410 MHz-7125 MHz |
|---|---|---|
| FR2 | FR2-1 | 24250 MHz-52600 MHz |
| | FR2-2 | 52600 MHz-71000 MHz |

In next generation cellular standards (e.g., 6G), in addition to FR1 and FR2, new carrier frequency bands can be considered, e.g., terahertz (>100 GHz) and FR3 or upper mid-band (7-24 GHz). The number of antenna ports that can be supported for these new bands is likely to be different from FR1 and FR2. In particular, for 7-15 GHz band, the max number of antenna ports is likely to be more than FR1, due to smaller antenna form factors, and feasibility of fully digital beamforming (as in FR1) at these frequencies. For instance, the number of CSI-RS antenna ports can grow up to 128. Besides, the NW deployment/topology at these frequencies is also expected to be denser/distributed, for example, antenna ports distributed at multiple (potentially non-co-located, hence geographically separated) TRPs or O-RUs within a cellular region can be the main scenario of interest, due to which the number of CSI-RS antenna ports for MIMO can be even larger (e.g., up to 256).

A (spatial or digital) precoding/beamforming can be used across these large number of antenna ports in order to achieve MIMO gains. Depending on the carrier frequency, and the feasibility of RF/HW-related components, the (spatial) precoding/beamforming can be fully digital or hybrid analog-digital. In fully digital beamforming, there can be one-to-one mapping between an antenna port and an antenna element, or a ‘static/fixed’ virtualization of multiple antenna elements to one antenna port can be used. Each antenna port can be digitally controlled. Hence, a spatial multiplexing across all antenna ports is possible.

As described herein, the NW topology/architecture is likely to be more and more distributed in future (e.g., 6G) due to reasons explained herein (e.g., use cases, HW requirements, antenna form factors, mobility etc.). In this disclosure, such a distributed system is referred to as a DMIMO or multiple TRP (mTRP) system (multiple antenna port groups, which can be non-co-located). The transmission in such a system can be coherent joint transmission (CJT), i.e., a layer can be transmitted across/using multiple TRPs, or non-coherent joint transmission (NCJT). Due to distributed nature of operation, the groups of antenna ports (or TRPs) need to be calibrated/synchronized by compensating for the non-idealities such as time/frequency/phase offsets non-ideal backhaul across TRPs, due to HW impairments, different delay profiles, and Doppler profile (in high-speed scenarios) associated with different TRPs.

In one example, a TRP can be functionally equivalent to (hence can be replaced with) or is interchangeable with one of more of the following: an antenna, or an antenna group (multiple antennae), an antenna port, an antenna port group (multiple ports), a CSI-RS resource, multiple CSI-RS resources, a CSI-RS resource set, multiple CSI-RS resource sets, an antenna panel, multiple antenna panels, a Tx-Rx entity, a (analog) beam, a (analog) beam group, a cell, a cell group.

FIG. 10 illustrates a diagram of example RAN configurations 1000 according to embodiments of the present disclosure. For example, RAN configurations 1000 can be implemented by the BS 102 of FIG. 1. This example is for illustration only and other embodiments can be used without departing from the scope of the present disclosure.

In an O-RAN, a TRP can be functionally equivalent to (hence can be replaced with) or is interchangeable with one of more of the following:
One RU or O-RU: a logical node that includes a subset of the eNB/gNB functions (e.g., as listed in clause 4.2 split option 7-2x)
More than one RUs or O-RUs
One or more than one RUs or O-RUs

Two examples are shown in FIG. 10.

The following are defined in [REF11 and REF12].

| | |
|---|---|
| O-CU | O-RAN Central Unit - a logical node hosting PDCP, RRC, |
| | SDAP and other control functions |
| O-DU | O-RAN Distributed Unit: a logical node hosting |
| | RLC/MAC/High-PHY layers based on a lower layer functional |
| | split. O-DU in addition hosts an M-Plane instance. |
| O-RU | O-RAN Radio Unit: a logical node hosting Low-PHY layer and |
| | RF processing based on a lower layer functional split. This |
| | is similar to 3GPP's “TRP” or “RRH” but more specific |
| | in including the Low-PHY layer (FFT/iFFT, PRACH |
| | extraction). O-RU in addition hosts M-Plane instance. |

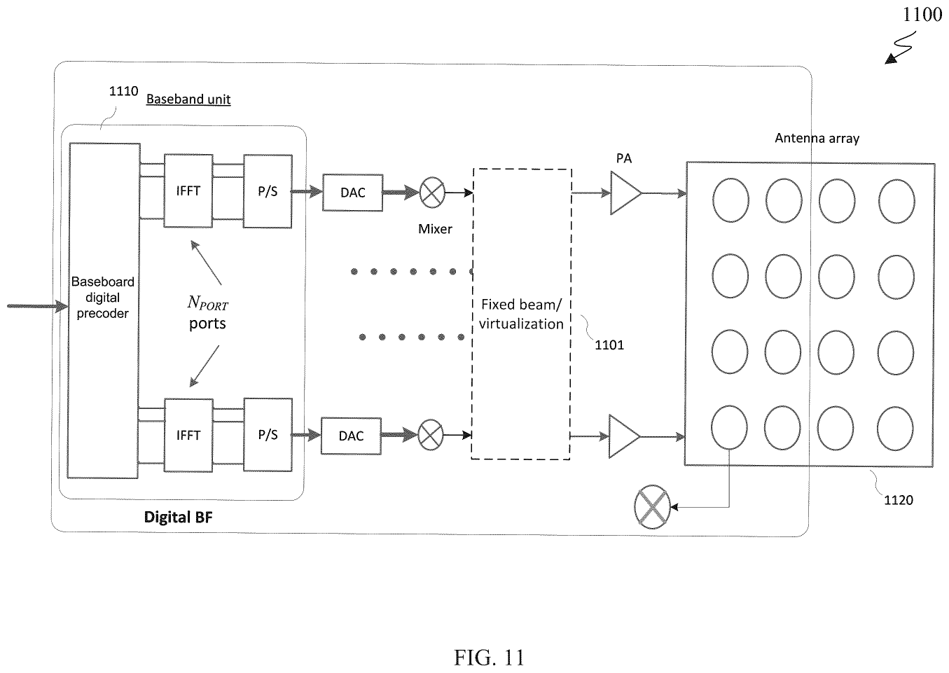

FIG. 11 illustrates an example of a fully digital transmitter structure 1100 for beamforming according to embodiments of the present disclosure. For example, fully digital transmitter structure 1100 can be implemented in the BS 102 of FIG. 2. This example is for illustration only and other embodiments can be used without departing from the scope of the present disclosure.

The fully digital transmitter structure 1100 includes a digital beamformer 1110, a fixed beam/virtualization 1101, and antenna array angles 1120.

A NW can be built upon a spatial resource entity, say X (e.g., TRP or O-RU). For FR1/FR3, the spatial entity X comprises one or more antenna ports that are fully-digital (i.e., each antenna port is driven by a dedicated baseband processing chain), as shown in FIG. 11; and in FR2, the entity X comprises one or more antenna panels (sub-arrays), each comprising one (or two) antenna ports that is (are) controlled by analog phase shifters that result in an analog beam (pointing in certain spatial direction), as shown in FIG. 5. An antenna port in FR1/FR3 can also be beam-formed (aka virtualization); however, such a beamforming (BF) is generally static (non-adaptive, hence does not requiring measurement and reporting). In FR2, due to large propagation loss at mmWave frequencies, each antenna panel requires dynamic frequent update of the analog BF, which is often based on (analog) beam measurement and reporting.

A communication between the 5GNW and a user is broadly based on: (A1) NW resources, and (A2) signaling components, where the former corresponds to spatial-domain, frequency-domain, and time-domain (SD, FD, TD) resources allocated to the user for the communication, and the latter corresponds to components that are signaled over the NW resources. The SD resources can be based on a single TRP (sTRP) or multiple TRPs (mTRP), where mTRP can be (B1) co-located at a site/location or (B2) non-co-located/distributed at multiple sites/locations, where the latter corresponds to a distributed SD resource, hence the corresponding communication hypothesis can be (C1) non-coherent joint transmission (NCJT) where a data stream (layer) is transmitted from one of the mTRPs, or (C2) coherent JT (CJT), where a data stream (layer) can be transmitted from multiple of the mTRPs. The FD resources can comprise a set of PRBs, and the TD resources can comprise one or multiple time slots (i.e., 1 slot=N_{sym} consecutive symbols).

The signaling components include signaling associated with (D1) measurement, (D2) channel state information (CSI) report, and (D3) DL reception or UL transmission.

For (D1), the user measures channel measurement RSs (CMRs) to estimate the channel condition between the sTRP/mTRP and the user. In case of sTRP, the user can measure a set comprising one or multiple DL measurement resources. For mTRP, the measurement resources can be (E1) one resource set comprising one group per TRP, or (E2) one resource set per TRP. The user can also measure the interference based on interference measurement RSs (IMRs). A CMR can correspond to an analog beam, and can be repeated in multiple symbols for determining user's analog beam.

For (D2), the user, based on the measurement, determines the CSI and reports it to the NW, where the CSI can be (F1) (analog) beam-related CSI, or (F2) (digital) non-beam-related CSI. For (F1), the user determines one or multiple pairs (indicator, metric), where the indicator indicates a CMR and the metric indicates a (beam) quality (e.g., RSRP, SINR).

For (F2), a low-resolution (Type-I) CSI and a high-resolution (Type-II) CSI can be supported. The Type-I CSI can be based on L=1 DFT SD vector per layer. The Type-II CSI is based on a weighted linear combination L>1 SD DFT vectors where the weights correspond to coefficients. The FD DFT vectors can also be introduced to reduce the CSI feedback overhead by compressing channel coefficients in both SD and FD. Type-I or Type-II CSI can also be extended to support NCJT or CJT CSI from mTRP and/or for high/medium user velocities by exploiting time-domain correlation or Doppler-domain information.

A unified transmission configuration indication (uTCI) framework supports signaling of a unified TCI state to a user, where the unified TCI state can be a DL-TCI, an UL-TCI or a joint TCI (J-TCI) state, where a DL-TCI state is applied for receiving DL channels/signals, an UL-TCI state is applied for transmitting UL channels/signals, and a J-TCI state is applied for both DL and UL channels/signals. The uTCI framework is designed to support DL receptions and UL transmissions (i) with a joint (common) beam indication for DL and UL by leveraging beam correspondence (reciprocity between DL and UL), and (ii) with separate beam indications for DL and UL, for example to mitigate maximum permissible exposure, where the beam direction of an UL transmission is different from the beam direction of a DL reception to avoid exposure of the human body to radiation.

The uTCI framework can support a beam-level mobility, known as inter-cellBM (ICBM). In ICBM, the user-dedicated channels can be configured to use a beam (i.e., TCI state) associated with a (non-serving) cell having a physical cell identity (PCI) that is different from the PCI of the serving cell. This allows fast beam-switch to a non-serving cell for user-dedicated channels at a lower layer without involving a higher layer and without incurring latency and overhead of handover.

The ICBM can be followed by a complete cell-switch triggered by lower layers, which is known as lower-layer triggered mobility (LTM). In LTM, the NW can acquire beam measurements, and UL timing information for target candidate cells before cell-switch. The lower layers of the NW decide when to perform a cell-switch, and send a medium access control channel element (MAC CE) containing a cell-switch command (CSC) that triggers the cell-switch from a source cell to a target cell. The CSC includes beam (i.e., TCI state) and UL timing information for the user to use on the target cell. After a beam application delay, the user and the NW communicates via the target cell.

Full-duplex transmission and reception in the same channel BW or using non-contiguous intra-band carrier aggregation (CA) is a promising technology to enhance UL coverage, reduce latency and improve system capacity and to overcome limitations inherent to the use of de-facto mandated semi-static TDD UL-DL frame configurations in today's TDD deployments. In NW-side subband full-duplex (SBFD) mode, simultaneous transmissions and receptions by the NW on the same time-domain symbol on the NR carrier can occur in non-overlapping UL and DL subbands. The users with support for NW-side SBFD operation still operate in half-duplex, i.e., the user can either transmit or receive on an SBFD symbol but not transmit and receive simultaneously. An SBFD UL subband can be located in the center or at the edge of the NR carrier in FR1 or FR2-1. For CA-based SBFD in FR2-1, one component carrier (CC) can be allocated for UL transmissions whereas the remaining CCs can be used for DL transmission. NW-side self-interference cancellation (SIC) capability to enable SBFD can be realized through a combination of solutions. For example, the NW can use Tx/Rx antenna isolation on the antenna panel(s), beam steering, analog and/or digital pre-distortion, digital interference cancellation, and analog and/or digital filtering solutions.

As explained, the 5GNW can support several features, services, use cases, and deployment scenarios. It however also introduces too many different abstractions (for specification) of NW entities and involved signaling for components of these abstractions. A direct scaling/extension/reuse of these legacy up to 5G solutions for 6G will add to the complexity, which is undesired in real NW deployments.

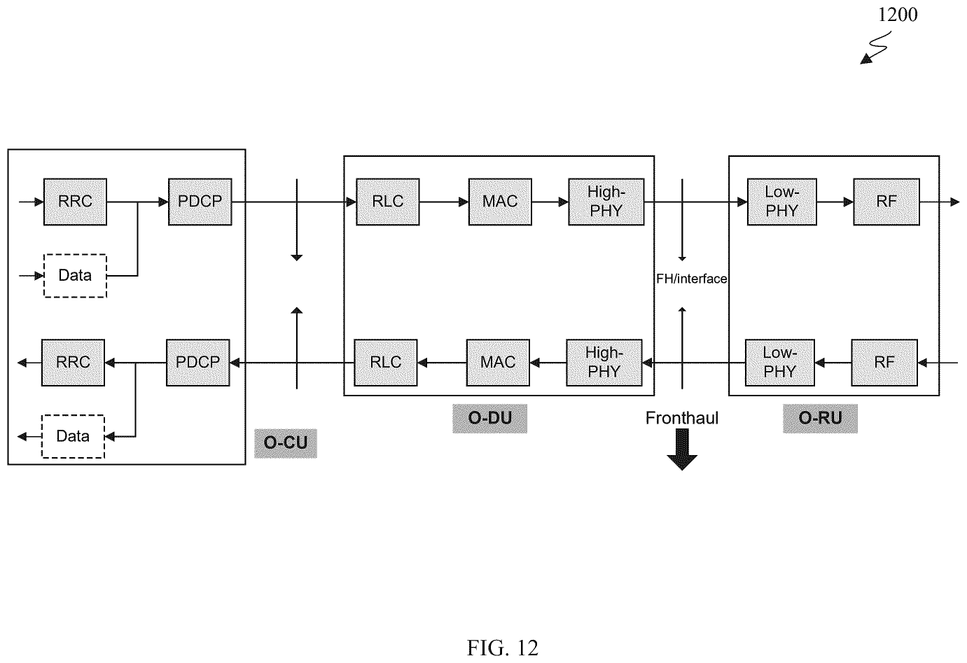

FIG. 12 illustrates a diagram of example functional split points/options 1200 according to embodiments of the present disclosure. For example, functional split points/options 1200 may be implemented by the BS 103 of FIG. 1. This example is for illustration only and other embodiments can be used without departing from the scope of the present disclosure.

Embodiments of the present disclosure recognize that in next-gen MIMO systems (e.g., 6G), at least two aspects need to be evaluated.
(A) A single band-agnostic NW entity, namely a port, and an associated QCL information/relation (e.g., via a TCI state) with a source RS (or analog beam). For CSI, multiple ports or a port group (PG) (as a collection of ports) can be used.
(B) NW architecture as perceived in O-RAN: The functionality split among O-RAN entities for DL and UL operations, such as O-RU, 0-DU, and O-CU (as described herein). An example is shown in FIG. 11. In particular, the PHY functionality split between O-DU and O-RU includes at least the following aspects.
   (B1) PHY processing:
      bit-level processing,
      symbol-level processing
   (B2) Scheduling (residing in MAC): SU-MIMO/MU-MIMO scheduling across different O-RUs and/or allocated frequency-domain resources (e.g., PRBs, PRGs, SBs)
      Utilizing UCI carrying CSI
      If DL/UL reciprocity is feasible, also utilizing SRS-based channel measurement
   (B3) Precoder calculation at a gNB (NW side) for DL-SCH transmission:
      For SU-MIMO, precoder can simply follow the PMI (calculated expecting SU-MIMO hypothesis) reported by the UE, or, if DL/UL reciprocity is feasible, be calculated from the eigenvector(s) of the measured DL channels.
      For MU-MIMO, precoder needs to be calculated based on additional orthogonalization (e.g., ZFBF, SLNR) among PMIs, or, if DL/UL reciprocity is feasible, the eigenvectors of the measured channels of the co-scheduled UEs

A few relevant (more-probable) candidates discussed in the O-RAN Alliance (depicted in FIG. 12) are shown in Table 2.

TABLE 2
(both DL and UL)

| | | | | | | | |
|---|---|---|---|---|---|---|---|
| | | | High- | Low- | | | |
| PDCP | RLC | MAC | PHY | PHY | RF | HLS | LLS |

| | | | | | |
|---|---|---|---|---|---|
| O-RAN¹ | O-CU: | O-DU: RLC, MAC, High- | O-RU: Low-PHY, | Y | symbol- |
| (Opt7-2x) | PDCP | PHY | RF | | level PHY |
| Opt7-3 | O-CU: | O-DU: RLC, MAC, High- | O-RU: Low-PHY, | Y | bit-level |
| | PDCP | PHY | RF | | PHY |

| | | | | |
|---|---|---|---|---|
| Opt8 | DU: RLC, MAC, PHY | RU: | Y | CPRI |

RF

O-RAN¹: [REF 12]

Cat-A, Cat-B
UL: Cat-C

The main difference between a FR1/FR3 port and a FR2 panel is that the beam/virtualization (i.e., port assignment) is fixed in the former, and it requires (a) measurement and reporting from UE and (b) a beam indication from the NW (e.g., TCI state with QCL-TypeD source RS). It is therefore plausible to have a unified framework in which a port in FR1 and a panel in FR2 can be abstracted based on a unified, band-agnostic spatial entity, e.g., port or port group (PG), and associated QCL and coherency properties across ports or PGs (intra-/inter PG). For instance,
Port: a FR1/FR3 port and a FR2 beam/source
FR2: multiple ports/beams for CSI acquisition and DL/UL transmission
FR1/FR3: a port group (PG), a collection/set/group of ports for CSI acquisition and DL/UL transmission

While the O-RAN Alliance is intended for 5G NR, it is expected that its framework will continue, or at most refined, for 6G. The O-RAN Alliance specifies 3 levels of functional splits—namely CU, DU, and RU—to facilitate multi-vendor inter-operability within a NW. The manner in which PHY-layer functions are split between DU and RU(s) imposes serious impact on the feasibility, performance, and complexity of different MIMO schemes—mainly due to the latency and quantization loss incurred by the O-RAN-standardized RU-DU interface.

In this sense, a “port” can be associated with a digital port in FR1/FR3 or an analog beam in FR2 (thereby abandoning the 5G association between an analog beam and a CSI-RS resource for FR2).

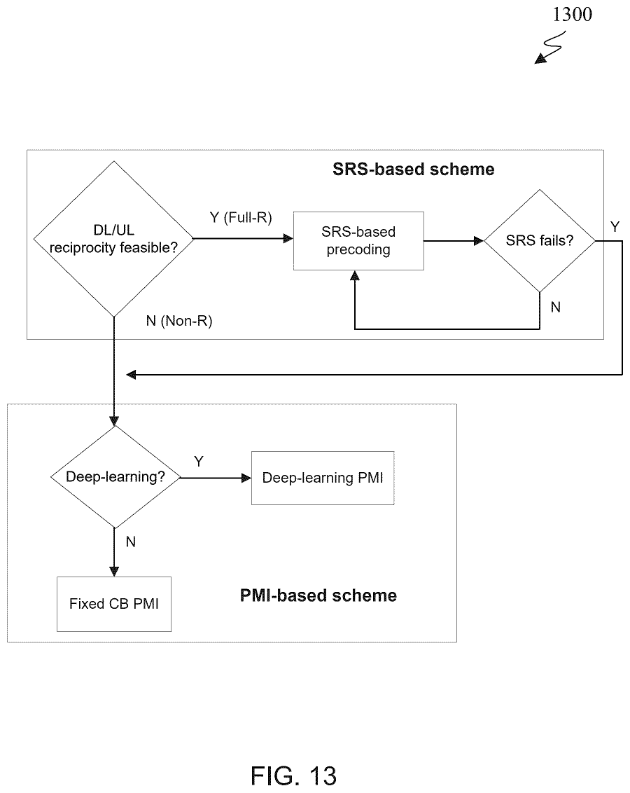

FIG. 13 illustrates an example of download precoding schemes 1300 according to embodiments of the present disclosure. For example, download precoding schemes 1300 may be implemented by the BS 103 of FIG. 1. This example is for illustration only and other embodiments can be used without departing from the scope of the present disclosure.

The precoding in a DL transmission scheme can be SRS-based or PMI-based, as shown in FIG. 13, where the SRS-based scheme can be used when the DL-UL reciprocity is feasible and SRS channel measurement is possible (i.e., UL SNR of channel measurement is not too small). When SRS fails (e.g., due to low UL SNR) or full DL/UL reciprocity is infeasible, PMI-based DL precoding can be used. A two-stage W1W2 codebook with fixed basis W1 is limited in its utility due to (i) more diverse and less-structured antenna types, e.g., RIS, 3D cylindrical/semi-spherical antenna, (in addition to 2D planar array), (ii) distributed NW deployment/topology at least for low sub-1 GHz and FR3 due to large form factor and channel-sparsity/or rank-deficiency, respectively. To accommodate scalability and future-proofness, in addition to the PMI derived from a fixed-basis codebook, AI/ML- or deep-learning-based DL precoding can also be used. The training can be for a two-sided model (simultaneous/joint ENC-DEC training or sequential starting at NW and ending at UE). For NW or UE not capable of deep learning, the fixed-basis codebook PMI-based precoding can be used as a last resort as illustrated.

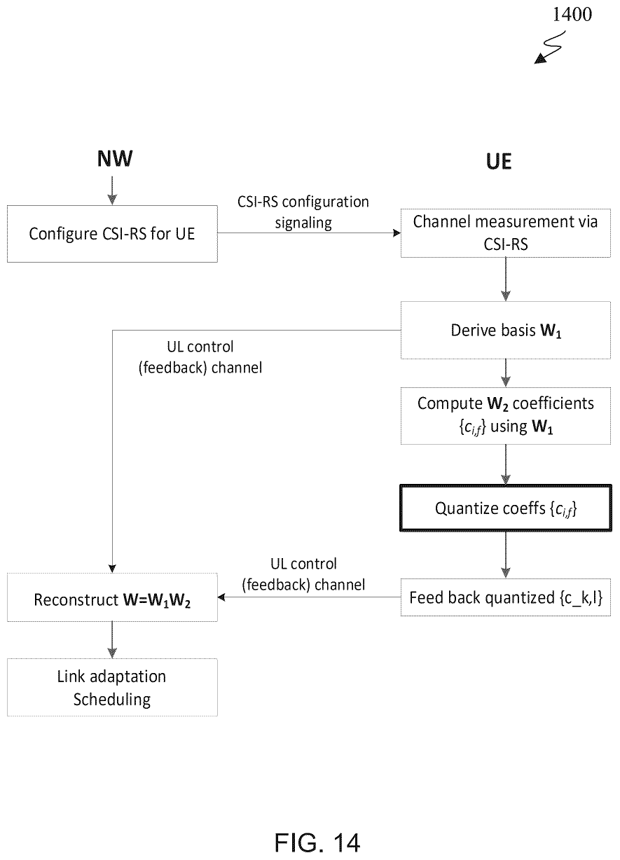

FIG. 14 illustrates a signal flow and procedure diagram 1400 according to embodiments of the present disclosure. For example, the signal flow procedure 1400 may be implemented by the UE 116 and the network 130 of FIG. 1. This example is for illustration only and can be used without departing from the scope of the present disclosure.

As illustrated, the signal flow and procedure diagram 1400 facilitates the UE's CSI report according to some embodiments of the present disclosure. The NW first configures CSI-RS for a UE. Then, estimating channels with configured CSI-RS and processing the channel estimates, the UE derives a basis W1 and corresponding W2 coefficients c_{i,f}. The UE then reports information on the basis W1 and quantized coefficients W2 to the NW.

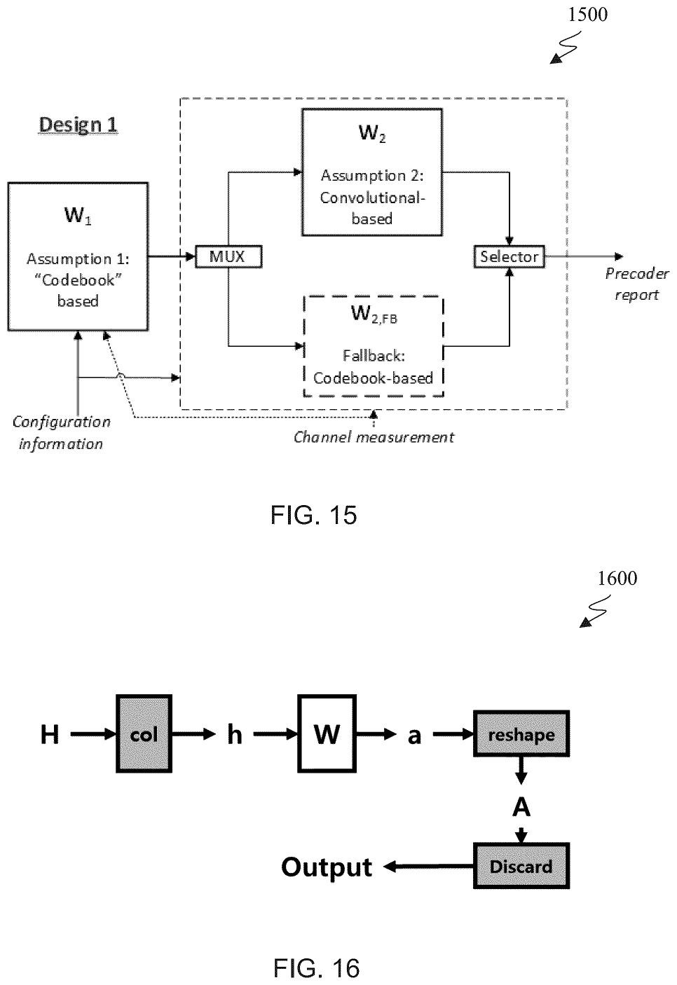

FIG. 15 illustrates a diagram of an example precoding procedure 1500 according to embodiments of the present disclosure. For example, the precoding procedure 1500 may be implemented by the BS 103 of FIG. 1. This example is for illustration only and can be used without departing from the scope of the present disclosure.

A deep-learning or AI/ML-based precoding and CSI feedback has a potential of providing better accuracy-overhead trade-off via non-linear compression. The following are the potential benefits of AI/ML-based CSI feedback.
Better performance, i.e., CSI feedback accuracy-overhead trade-off
Antenna panels/arrangements agnostic as opposed to the limitation of NR CBs to ULA
Better flexibility to support variable CSI feedback payload size
Capability to scale with a larger CSI dimensions (large number of ports, SD/FD/TD granularities, etc.)

The precoding can be based on a two-stages (W1W2): (i) Stage 1 for set of basis entities W1, where an entity can comprise spatial-, frequency- and/or time- (Doppler-) domain (SD, FD, DD) vectors, and (ii) Stage 2 for set of coefficients W2. There can be two assumptions regarding the antenna geometry/structure.
Assumption 1: dictated by (SD, FD, TD) properties, implying that a fixed codebook suffices.
Assumption 2: agnostic to (SD, FD, TD) properties, implying that there is need for a learning-based (e.g., AI/ML, convolutional, non-DFT) codebook component.

Here, (SD, FD, TD) properties include antenna geometry, compression dimensions, SD/FD/TD units, prediction, 2nd order channel stats, etc.

The (W1, W2) can be according to one of the following three types:
Design 1: W1 is codebook-based, and W2 is deep-learning-based (hence require training, e.g., via AI/ML approach).
Design 2: W1 is deep-learning-based (hence require training, e.g., via AI/ML approach), and W2 is codebook-based.
Design 3: W1 and W2 are deep-learning-based (may require training, e.g., via AI/ML approach).

In Design 1, (shown in FIG. 15), W1 is according to Assumption 1, implying that it can be CB-based, and W2 is according to Assumption 2, implying that it can be training-based (e.g., convolutional). In Design 2, on the other hand, W1 is according to Assumption 2, implying that it can be learning-based e.g., Toeplitz (single, doubly), and W2 is according to Assumption 1, implying that it can be CB-based. The fixed W1 codebook (DFT-based or Slepian) can be used as fall-back and to initiate the precoding operation before switching to the leaning-based codebook.

In one example, it is assumed that an AI/ML model architecture can be designed to train an autoencoder (AE) for generating/reporting CSI feedback, where the encoder utilizes a single CNN layer. When this trained AE is used for inference, applying this CNN layer is equivalent to pre-multiplying its input by a Toeplitz (or doubly-block Toeplitz, circulant, doubly-block circulant, concatenation of doubly-block Toeplitz/circulant) matrix. For example, 1-D linear convolution is equivalent to pre-multiplication by a Toeplitz matrix, while 2-D linear convolution is equivalent to pre-multiplication by a doubly-block Toeplitz matrix. Also, 1-D circular convolution is equivalent to pre-multiplication by a circulant matrix, while 2-D circular convolution is equivalent to pre-multiplication by a doubly-block circulant matrix. In addition, 3-D linear convolution is equivalent to pre-multiplication by a matrix that consists of a concatenation of doubly-block Toeplitz matrices [8].

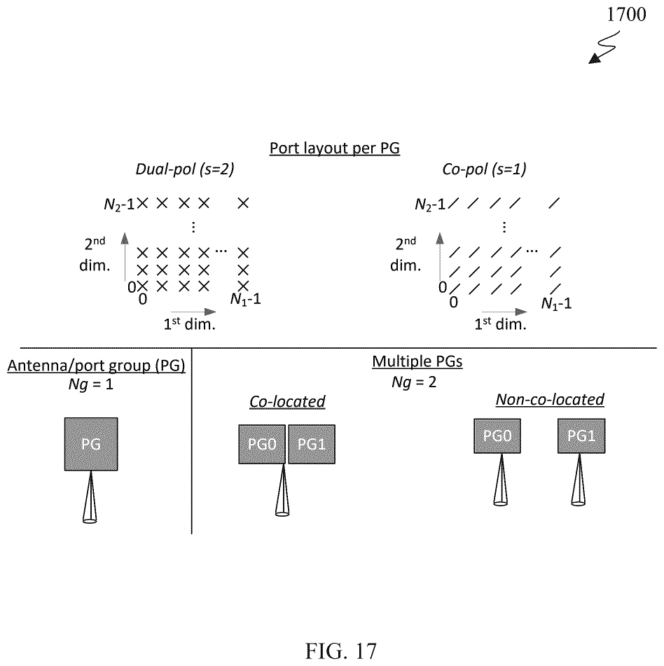

FIG. 16 illustrates a diagram of an example CNN 1600 according to embodiments of the present disclosure. For example, CNN 1600 can be implemented by any of the UEs 111-116 of FIG. 1. This example is for illustration only and other embodiments can be used without departing from the scope of the present disclosure.

An example is shown in FIG. 16 for a single layer CNN, where the Kernel is a vector/matrix (e.g., a vector if learning/training is only SD, and a matrix if it is on both SD and FD). The Convolution is equivalent to the following:
Create column vector from input H, i.e., h
α=Wh (where W is a Kernel matrix/vector based on doubly-block Toeplitz)
   Zero-pad kernel to create W
Reshape α to matrix A
   For each row in A, discard all entries from partial kernel overlap with H

The W is essentially a Toeplitz matrix when the Kernel is a vector, and a doubly Toeplitz matrix when the Kernel is a matrix. A Toeplitz matrix [5] has constant (same) values along its negative-sloping diagonals; an example is shown in (1) as values . . . , a₋₁, a₀, a₁, . . . .

$$A = [ \begin{matrix}{a}_{0} & {a}_{- 1} & {a}_{- 2} & … & {a}_{- n + 1} \\ {a}_{1} & {a}_{0} & {a}_{- 1} & ⋱ & ⋮ \\ {a}_{2} & {a}_{1} & {a}_{0} & ⋱ & {a}_{- 2} \\ ⋮ & ⋱ & ⋱ & ⋱ & {a}_{- 1} \\ {a}_{n - 1} & … & {a}_{2} & {a}_{1} & {a}_{0}\end{matrix} ] \qquad ( 1 )$$

A doubly-block Toeplitz matrix [6] is a block matrix R where 1) its (i,j)-th block Rᵢⱼ is a function of i-j (thus, it can be denoted by Rᵢ₋ⱼ) and 2) Rᵢⱼ(denoted by Rᵢ₋ⱼ) is itself a Toeplitz matrix. An example is shown in (2), where each Rⱼ is a Toeplitz matrix.

$$R = [ \begin{matrix}{R}_{0} & {R}_{- 1} & {R}_{- 2} & … & {R}_{- n + 1} \\ {R}_{1} & {R}_{0} & {R}_{- 1} & ⋱ & ⋮ \\ {R}_{2} & {R}_{1} & {R}_{0} & ⋱ & {R}_{- 2} \\ ⋮ & ⋱ & ⋱ & ⋱ & {R}_{- 1} \\ {R}_{n - 1} & … & {R}_{2} & {R}_{1} & {R}_{0}\end{matrix} ] \qquad ( 2 )$$

A circulant matrix [7] is a special case of a Toeplitz matrix where each row (column) is a circular shift of the previous row (column). An example is shown in (3).

$$A = [ \begin{matrix}{a}_{0} & {a}_{- 1} & {a}_{- 2} & … & {a}_{- n + 1} \\ {a}_{- n + 1} & {a}_{0} & {a}_{- 1} & ⋱ & {a}_{- n + 2} \\ {a}_{- n + 2} & {a}_{- n + 1} & {a}_{0} & ⋱ & {a}_{- n + 3} \\ ⋮ & ⋱ & ⋱ & ⋱ & ⋮ \\ {a}_{- 1} & … & {a}_{- n + 2} & {a}_{- n + 1} & {a}_{0}\end{matrix} ] \qquad ( 3 )$$

A doubly-block circulant matrix is a special case of a doubly-block Toeplitz matrix R where 1) each block row (column) is a circular shift of the previous block row (column) and 2) its (i,j)-th block Rᵢⱼ(denoted by Rᵢ₋ⱼ) is itself a circulant matrix. An example is shown in (4), where each Rⱼ is a circulant matrix.

$$R = [ \begin{matrix}{R}_{0} & {R}_{- 1} & {R}_{- 2} & … & {R}_{- n + 1} \\ {R}_{- n + 1} & {R}_{0} & {R}_{- 1} & ⋱ & {R}_{- n + 2} \\ {R}_{- n + 2} & {R}_{- n + 1} & {r}_{0} & ⋱ & {R}_{- n + 3} \\ ⋮ & ⋱ & ⋱ & ⋱ & ⋮ \\ {R}_{- 1} & … & {R}_{- n + 2} & {R}_{- n + 1} & {R}_{0}\end{matrix} ] \qquad ( 4 )$$

Thus, using this trained autoencoder for inference is equivalent to applying a Toeplitz-based method for generating/reporting CSI feedback. This Toeplitz-based method can utilize a flexible basis that depends on a training dataset.

Accordingly, various embodiments of the present disclosure propose design alternatives for deep-learning based W2. Further, various embodiments of the present disclosure propose support of AIML-based or deep-learning-based training of the W2 codebook, in particular amplitude codebook, including information elements to be exchanged between a transmitter and a receiver. Further still, various embodiments of the present disclosure propose, for the use case of the CSI report: joint encoding/reporting of bitmap (indicating indices of non-zero coefficients) and amplitudes of NZ coefficients; variable length encoder for coefficient amplitude reporting; and details on signaling (between the NW and the UE) and reporting (from the UE).

The present disclosure relates generally to wireless communication systems and, more specifically, to deep-learning-based precoding in next generation of communication (e.g., 6G) systems.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

In the following, for brevity, both frequency division duplexing (FDD) and time division duplexing (TDD) are provided as the duplex method for both DL and UL signaling.

Although exemplary descriptions and embodiments to follow expect orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure covers several components which can be used in conjunction or in combination with one another, or can operate as standalone schemes.

Depending on the network type, the term “base station” or “BS” can refer to any component (or collection of components) configured to provide wireless access to a network, such as transmit point (TP), transmit-receive point (TRP), an enhanced base station (eNodeB or eNB), gNB, a macrocell, a femtocell, a WiFi access point (AP), or other wirelessly enabled devices. Base stations may provide wireless access in accordance with one or more wireless communication protocols, e.g., 5G 3GPP New Radio Interface/Access (NR), long term evolution (LTE), LTE advanced (LTE-A), High Speed Packet Access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

All the following components and embodiments are applicable for UL transmission with CP-OFDM (cyclic prefix OFDM) waveform as well as DFT-SOFDM (DFT-spread OFDM) and SC-FDMA (single-carrier FDMA) waveforms. Furthermore, the following components and embodiments are applicable for UL transmission when the scheduling unit in time is either one subframe (which can include one or multiple slots) or one slot.

In the present disclosure, the frequency resolution (reporting granularity) and span (reporting bandwidth) of CSI reporting can be defined in terms of frequency “subbands” and “CSI reporting band” (CRB), respectively.

A subband for CSI reporting is defined as a set of contiguous PRBs which represents the smallest frequency unit for CSI reporting. The number of PRBs in a subband can be fixed for a given value of DL system bandwidth, configured either semi-statically via higher-layer/RRC signaling, or dynamically via L1 DL control signaling or MAC control element (MAC CE). The number of PRBs in a subband can be included in CSI reporting setting.

“CSI reporting band” is defined as a set/collection of subbands, either contiguous or non-contiguous, wherein CSI reporting is performed. For example, CSI reporting band can include the subbands within the DL system bandwidth. This can also be termed “full-band”. Alternatively, CSI reporting band can include only a collection of subbands within the DL system bandwidth. This can also be termed “partial band”.

The term “CSI reporting band” is used only as an example for representing a function. Other terms such as “CSI reporting subband set” or “CSI reporting bandwidth” or bandwidth part (BWP) can also be used.

In terms of UE configuration, a UE can be configured with at least one CSI reporting band. This configuration can be semi-static (via higher-layer signaling or RRC) or dynamic (via MAC CE or L1 DL control signaling). When configured with multiple (N) CSI reporting bands (e.g., via RRC signaling), a UE can report CSI associated with n≤N CSI reporting bands. For instance, >6 GHz, large system bandwidth may require multiple CSI reporting bands. The value of n can either be configured semi-statically (via higher-layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mₙ subbands when one CSI parameter for the Mₙ subbands within the CSI reporting band. A CSI parameter is configured with “subband” for the CSI reporting band with Mₙ subbands when one CSI parameter is reported for each of the Mₙ subbands within the CSI reporting band.

FIG. 17 illustrates a diagram of an example antenna port layout 1700 according to embodiments of the present disclosure. For example, antenna port layout 1700 can be implemented in the wireless network 100 of FIG. 1. This example is for illustration only and can be used without departing from the scope of the present disclosure.

In the following, N₁ and N₂ are the number of antenna ports with the same polarization in the first and second dimensions, respectively. For 2D antenna port layouts, N₁>1, N₂>1, and for 1D antenna port layouts N₁>1 and N₂=1 or N₂>1 and N₁=1. In the rest of the disclosure, 1D antenna port layouts with N₁>1 and N₂=1 is provided. The disclosure, however, is applicable to the other 1D port layouts with N₂>1 and N₁=1. Also, in the rest of the disclosure, N₁≥N₂. The disclosure, however, is applicable to the case when N₁<N₂, and the embodiments for N₁>N₂ apply to the case N₁<N₂ by swapping/switching (N₁, N₂) with (N₂, N₁). For a single-polarized (or co-polarized) antenna port layout, the total number of antenna ports is P_{CSIRS}=N₁N₂. And, for a dual-polarized antenna port layout, the total number of antenna ports is P_{CSIRS}=2N₁N₂. An illustration is shown in FIG. 13 where “X” represents two antenna polarizations (dual-pol, s=2) and “/” represents one antenna polarization (co-pol, s=1). In this disclosure, the term “polarization” refers to a group of antenna ports with the same polarization. For example, antenna ports

$$j = X + 0 , X + 1 , … , X + \frac{{P}_{CSIRS}}{2} - 1$$

comprise a first antenna polarization, and antenna ports

$$j = X + \frac{{P}_{CSIRS}}{2} , X + \frac{{P}_{CSIRS}}{2} + 1 , … , X + {P}_{CSIRS} - 1$$

comprise a second antenna polarization, where P_{CSIRS} is a number of CSI-RS antenna ports and X is a starting antenna port number (e.g., X=3000, then antenna ports are 3000, 3001, 3002, . . . ). Unless stated otherwise, dual-polarized antenna layouts are expected in this disclosure. The embodiments (and examples) in this disclosure however are general and are applicable to single-polarized antenna layouts as well.

Let s denote the number of antenna polarizations (or groups of antenna ports with the same polarization). Then, for co-polarized antenna ports, s=1, and for dual- or cross (X)-polarized antenna ports s=2. So, the total number of antenna ports P_{CSIRS}=s₁N₂.

Let N_{g} be a number of antenna/port groups (PGs). When there are multiple antenna/port groups (N_{g}>1), each group (g∈{1, . . . , N_{g}}) comprises N_{1,g} and N_{2,g} ports in two dimensions. This is illustrated in FIG. 13. Note that the antenna port layouts may be the same (N_{1,g}=N₁ and N_{2,g}=N₂) in different antenna/port groups, or they can be different across antenna/port groups. For group g, the number of antenna ports is P_{CSIRS,g}=N_{1,g}N_{2,g} or 2N_{1,g}N_{2,g}(for co-polarized or dual-polarized respectively), i.e., P_{CSIRS,g}=s_{g}N_{1,g}N_{2,g} where s_{g}=1 or 2.

In one example, an antenna/port group corresponds to an antenna panel. In one example, an antenna/port group corresponds to a TRP. In one example, an antenna/port group corresponds to an RRH. In one example, an antenna/port group corresponds to CSI-RS antenna ports of a NZP CSI-RS resource. In one example, an antenna/port group corresponds to a subset of CSI-RS antenna ports of a NZP CSI-RS resource (comprising multiple antenna/port groups). In one example, an antenna/port group corresponds to CSI-RS antenna ports of multiple NZP CSI-RS resources (e.g., comprising a CSI-RS resource set).

In one example, an antenna/port group corresponds to a reconfigurable intelligent surface (RIS) in which the antenna/port group can be (re-)configured more dynamically (e.g., via MAC CE and/or DCI). For example, the number of antenna ports associated with the antenna/port group can be changed dynamically.

In one example, the antenna architecture of the MIMO system is structured. For example, the antenna structure at each PG or O-RU (or RU) is dual-polarized (single or multi-panel as shown in FIG. 13. The antenna structure at each PG or O-RU (or RU) can be the same. Or the antenna structure at an PG or O-RU (or RU) can be different from another PG or O-RU (or RU). Likewise, the number of ports at each PG (OR O-RU OR RU) can be the same. Or the number of ports at one PG (OR O-RU OR RU) can be different from another PG (OR O-RU OR RU).

In another example, the antenna architecture of the MIMO system is unstructured. For example, the antenna structure at one PG (OR O-RU OR RU) can be different from another PG (OR O-RU OR RU).

A structured antenna architecture is expected in the rest of the disclosure. For simplicity, each PG (OR O-RU OR RU) is equivalent to a panel (cf. FIG. 13), although, an PG (OR O-RU OR RU) can have multiple panels in practice. The disclosure however is not restrictive to a single panel expectation at each PG (OR O-RU OR RU), and can easily be extended (covers) the case when an PG (OR O-RU OR RU) has multiple antenna panels.

In one or more embodiments described herein, a PG (OR O-RU OR RU) constitutes (or corresponds to or is equivalent to) at least one of the following:
In one or more examples described herein, an PG OR O-RU (OR RU) corresponds to a TRP.
In one or more examples described herein, an PG or O-RU (or RU) corresponds to a CSI-RS resource. AUE is configured with K=N_{g}>1 non-zero-power (NZP) CSI-RS resources, and a CSI reporting is configured to be across multiple CSI-RS resources. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein.
In one or more examples described herein, an PG or O-RU (or RU) corresponds to a CSI-RS resource group, where a group comprises one or multiple NZP CSI-RS resources. A UE is configured with K≥N_{g}>1 non-zero-power (NZP) CSI-RS resources, and a CSI reporting is configured to be across multiple CSI-RS resources from resource groups. This is similar to Class B, K>1 configuration in Rel. 14 LTE. The K NZP CSI-RS resources can belong to a CSI-RS resource set or multiple CSI-RS resource sets (e.g., K resource sets each comprising one CSI-RS resource). The details are as explained in this disclosure herein. In particular, the K CSI-RS resources can be partitioned into N_{g} resource groups. The information about the resource grouping can be provided together with the CSI-RS resource setting/configuration, or with the CSI reporting setting/configuration, or with the CSI-RS resource configuration.
In one or more examples described herein, a PG or O-RU (or RU) corresponds to a subset (or a group) of CSI-RS ports. A UE is configured with at least one NZP CSI-RS resource comprising (or associated with) CSI-RS ports that can be grouped (or partitioned) multiple subsets/groups/parts of antenna ports, each corresponding to (or constituting) an PG or O-RU (or RU). The information about the subsets of ports or grouping of ports can be provided together with the CSI-RS resource setting/configuration, or with the CSI reporting setting/configuration, or with the CSI-RS resource configuration.
In one or more examples described herein, an PG or O-RU (or RU) corresponds to or more examples described herein depending on a configuration. For example, this configuration can be explicit via a parameter (e.g., an RRC parameter). Or it can be implicit.
In one example, when implicit, it could be based on the value of K. For example, when K>1 CSI-RS resources, an PG or O-RU (or RU) corresponds to or more examples described herein, and when K=1 CSI-RS resource, an PG or O-RU (or RU) corresponds to or more examples described herein.
In another example, the configuration could be based on the configured codebook. For example, an PG or O-RU (or RU) corresponds to a CSI-RS resource or resource group when the codebook corresponds to a decoupled codebook (modular or separate codebook for each PG or O-RU (or RU)), and an PG or O-RU (or RU) corresponds to a subset (or a group) of CSI-RS ports when codebook corresponds to a coupled (joint or coherent) codebook (one joint codebook across PGs).

In one example, when PG or O-RU (or RU) maps (or corresponds to) a CSI-RS resource or resource group, and a UE can select a subset of PGs (resources or resource groups) and report the CSI for the selected PGs (resources or resource groups), the selected PGs can be reported via an indicator. For example, the indicator can be a CRI or a PMI (component) or a new indicator.

In one example, when PG or O-RU (or RU) maps (or corresponds to) a CSI-RS port group, and a UE can select a subset of PGs (port groups) and report the CSI for the selected PGs (port groups), the selected PGs can be reported via an indicator. For example, the indicator can be a CRI or a PMI (component) or a new indicator.

In one example, when multiple (K>1) CSI-RS resources are configured for N_{g} PGs, a decoupled (modular) codebook is used/configured, and when a single (K=1) CSI-RS resource for N_{g} PGs, a joint codebook is used/configured.

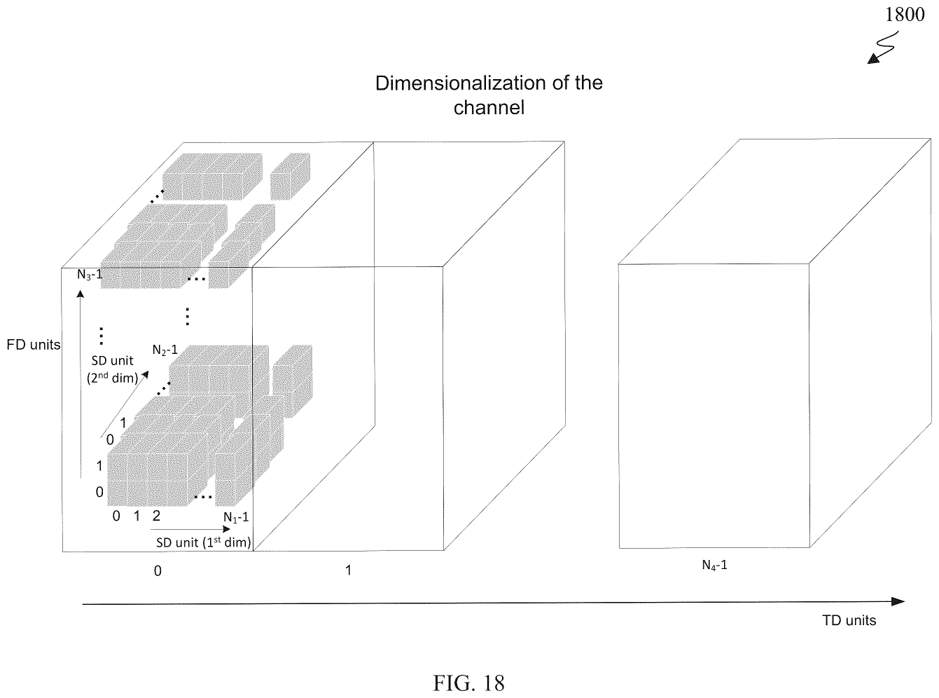

FIG. 18 illustrates a timeline 1800 of example SD units and FD units according to embodiments of the present disclosure. For example, timeline 1800 can be followed by any of the UEs 111-116 of FIG. 1. This example is for illustration only and other embodiments can be used without departing from the scope of the present disclosure.

In one embodiment, a UE is configured (e.g., via a higher layer CSI configuration information) with a CSI report, where the CSI report is based on a channel measurement (and interference measurement) and a codebook. When the CSI report is configured to be aperiodic, it is reported when triggered via a DCI field (e.g., a CSI request field) in a DCI.

The channel measurement can be based on K≥1 channel measurement resources (CMRs) that are transmitted from a plurality of spatial-domain (SD) units (e.g., a SD unit=a CSI-RS antenna port), and are measured via a plurality of frequency-domain (FD) units (e.g., a FD unit=one or more PRBs/SBs) and via either a time-domain (TD) unit or a plurality of TD units (e.g., a TD unit=one or more time slots). In one example, a CMR can be an NZP-CSI-RS resource.

The CSI report can be associated with the plurality of FD units and the plurality of TD units associated with the channel measurement. Alternatively, the CSI report can be associated with a second set of FD units (different from the plurality of FD units associated with the channel measurement) and/or a second set of TD units (different from the plurality of TD units associated with the channel measurement). In this later case, the UE, based on the channel measurement, can perform prediction (interpolation or extrapolation) in the second set of FD units and/or the second set of TD units associated with the CSI report.

An illustration of the SD units (in 1^{st} and 2^{nd} antenna dimensions), FD units, and, and TD units is shown in FIG. 18.
The first dimension is associated with the 1st antenna port dimension and comprises N₁ units,
The second dimension is associated with the 2nd antenna port dimension and comprises N₂ units,
The third dimension is associated with the frequency dimension and comprises N₃ units, and
The fourth dimension is associated with the time/Doppler dimension and comprises N₄ units.

Alternatively, the SD units, FD units, and, and TD units are as follows.
The first dimension is associated with the antenna port dimension and comprises P_{CSIRS} units,
The second dimension is associated with the frequency dimension and comprises N₃ units, and
The third dimension is associated with the time/Doppler dimension and comprises N₄ units.

The plurality of SD units can be associated with antenna ports (e.g., co-located at one site or distributed across multiple sites) comprising one or multiple antenna/port groups (i.e., N_{g}≥1), and dimensionalizes the spatial-domain profile of the channel measurement.

When K=1, there is one CMR comprising P_{CSIRS} CSI-RS antenna ports.
When N_{g}=1, there is one PG comprising P_{CSIRS} ports, and the CSI report is based on the channel measurement from the one PG.
When N_{g}>1, there are multiple PGs, and the CSI report is based on the channel measurement from/across the multiple PGs.

When K>1, there are multiple CMRs, and the CSI report is based on the channel measurement across the multiple CMRs. In one example, a CMR corresponds to an PG (one-to-one mapping). In one example, multiple CMRs can correspond to an PG (many-to-one mapping).

In one example, when the P_{CSIRS} antenna ports are co-located at one site, N_{g}=1. In one example, when of the P_{CSIRS} antenna ports are distributed (non-co-located) across multiple sites, N_{g}>1.

In one example, when the P_{CSIRS} antenna ports are co-located at one site and within a single antenna panel, N_{g}=1. In one example, when of the P_{CSIRS} antenna ports are distributed across multiple antenna panels (can be co-located or non-co-located), N_{g}>1.

The value of N_{g} can be configured, e.g., via higher layer RRC parameter. Or it can be indicated via a MAC CE. Or it can be provided via a DCI field.

Likewise, the value of K can be configured, e.g., via higher layer RRC parameter. Or it can be indicated via a MAC CE. Or it can be provided via a DCI field.

In one example, K=N_{g}=X. The value of X can be configured, e.g., via higher layer RRC parameter. Or it can be indicated via a MAC CE. Or it can be provided via a DCI field.

In one example, the value of K is determined based on the value of N_{g}. In one example, the value of N_{g} is determined based on the value of K.

The plurality of FD units can be associated with a frequency domain allocation of resources (e.g., one or multiple CSI reporting bands, each comprising multiple PRBs) and dimensionalizes the frequency (or delay)-domain profile of the channel measurement.

The plurality of TD units can be associated with a time domain allocation of resources (e.g., one or multiple CSI reporting windows, each comprising multiple time slots) and dimensionalizes the time (or Doppler)-domain profile of the channel measurement.

In one or more embodiments described herein, the data collection (based on the measurement at UE and/or gNB/RU/O-RU/PG) is according to at least one of the following examples.
In one example, the data collection is at a NW entity (e.g., O-CU, O-DU, or O-RU).
In one example, the data collection is at UE.
Transparent.
In one example, the data collection is at OAM (RAN3) which performs operations such as admin, maintenance.
In one example, the data collection is at OTT, a 3^{rd} party application for running AI/ML (getting data, modeling, and validation).

In one or more embodiments described herein, for the use case of CSI reporting (as explained herein), the measurement and data collection is according to one of the following examples.
In one example, the model training is @NW based on measurement of an RS.
   In one example, the RS is at least one UL RS (e.g., SRS) measured by the NW (e.g., one or multiple O-RUs).
   In one example, the RS is at least one DL RS (e.g., NZP CSI-RS) measured by the UE, and the UE reports/provides the measurement data (CSI-RS measurement or CSI report) to NW (e.g., O-RU)
In one example, the model training is @UE NW based on measurement of an RS.
   In one example, the RS is at least on DL RS (e.g., CSI-RS).
   In one example, the RS is at least on UL RS (e.g., SRS) and NW (O-RU) providing data (based on SRS measurement) to UE.

In one or more embodiments described herein, for the use case of CSI reporting (as explained herein), the model is one-sided, i.e., there is only one of encoder (ENC) and decoder (DEC). One side trains (e.g., W1) and transfers the model to the other side (e.g., offline).
In one example, the training is performed by NW and trained model is transferred to the UE.
In one example, the training is performed by UE and trained model is transferred to the NW.

In one or more embodiments described herein, for the use case of CSI reporting (as explained herein), the model is two-sided, i.e., there are both ENC and DEC.
In one example, one side trains (e.g., NW or UE), keeps ENC and transfers DEC to the other side (e.g., offline).
In one example, each side trains its part, for example, the ENC side trains ENC and DEC side trains DEC.
   In one example, the training is performed by both NW and UE. For example, the ENC is trained at NW and DEC is trained at UE.

In one example, for a two-sided model, both sides (NW or UE) has the same (or same type of) model. In one example, for a two-sided model, two sides (NW or UE) can have their own model, implying the two models may be the same or different.

In one example, the model training can be performed offline (e.g., once) or online (e.g., multiple times). In one example, the training is offline for a static or pedestrian UE or fixed wireless access device (e.g., CSI). In one example, the training is online for UE mobility and beam.

In one or more embodiments described herein, the model is a CNN or a transformer, and the training is one of both of basis and coefficients of the dual-stage precoder. Three examples of model type is shown in Table 3.

TABLE 3

| Example | Basis (W1, Wf, Wf) | W2 matrix |
|---|---|---|
| Example 1 | Fixed basis (e.g., DFT | Deep-learning based |
| | or Slepian) | |
| Example 2 | Deep-learning based | Fixed quantization |
| | | (CB-based) |
| Example 3 | Deep-learning based | Deep-learning based |

In Example 1, W1 is according to Assumption 1, implying that it can be CB-based, and W2 is according to Assumption 2, implying that it can be training-based (e.g., convolutional).
In Example 2, on the other hand, W1 is according to Assumption 2, implying that it can be learning-based e.g., Toeplitz (single, doubly), and W2 is according to Assumption 1, implying that it can be CB-based.
In Example 3, conversely, considers both W1 and W2 determination based on Assumption 1. One consideration here is W1 determination is cell/site-specific while W2 determination is cell/site/location agnostic, e.g., fully specified.

The legacy (DFT-based) codebook can be used as fall-back and to initiate the precoding operation before switching to the leaning-based codebook.

In the rest of the disclosure, a term “AIML-based” or “deep-learning-based” is used to indicate a training or learning of a parameter/entity (e.g., amplitude values or its distribution) based on data (e.g., CSI-RS measurement). Likewise, the term “non-AIML-based” is used to indicate no learning or training of a parameter/entity.

Let the coefficient matrix W₂ be of size K×M where K is associated with SD, and M is associated with FD (or a combination of FD and DD). In one example, K=2L.

$${W}_{2} = C = [ \begin{matrix}{c}_{0 , 0} & {c}_{0 , 1} & & {c}_{0 , M - 1} \\ ⋮ & ⋮ & … & ⋮ \\ {c}_{K - 1 , 0} & {c}_{K - 1 , 1} & & {c}_{K - 1 , M - 1}\end{matrix} ]$$

In one example, all {C_{i,f}} are reported. In one example, a subset of

$${K}_{l}^{NZ}$$

non-zero (NZ) coefficients {C_{i,f}} is reported and remaining coefficients C_{i,f}=0 hence not reported. Indices {(i, f)} of NZ coefficients can be indicated/reported via a bitmap indicator or a combinatorial indicator

$${i}_{1 , 7 , l} ∈ \{ 0 , 1 , … , ( \begin{matrix}K M \\ {K}_{l}^{N Z}\end{matrix} ) - 1 \} .$$

In Rel-16 enhanced Type II, indices {(i, f)} of NZ coefficients are indicated via a separate (bitmap) indicator (i_{1,7,l}) of size 2LM bits, where a bit value “1” indicates a NZ coefficient and a bit value “0” indicates a zero coefficient. For ν layers,

$${i}_{1 , 7 , l} = [ {k}_{l , 0}^{( 3 )} … {k}_{l , M - 1}^{( 3 )} ]$$

$${k}_{l , f}^{( 3 )} = [ {k}_{l , 0 , f}^{( 3 )} … {k}_{l , K - 1 , f}^{( 3 )} ]$$

$${k}_{l , i , f}^{( 3 )} ∈ \{ 0 , 1 \}$$

for l=1, . . . , ν, such that

$${K}_{l}^{NZ} = {\sum }_{i = 0}^{K - 1} {\sum }_{f = 0}^{M - 1} {k}_{l , i , f}^{( 3 )} \leq {K}_{0} ,$$

where K₀ is a max value (upper bound) on

$${K}_{l}^{NZ} .$$

Let K₀=┌βKM┐ where β<1. In one example,

$${K}^{NZ} = {\sum }_{l = 1}^{υ} {K}_{l}^{NZ} \leq Y .$$

In one example, Y=2K₀.

The amplitude and phase of the NZ coefficients are reported via separate indicators. There are at least two issues in Rel-16 W2 reporting due to which the W2 reporting payload (number of bits) can be large.
Issue 1: there is a redundancy (duplicacy) due to separate reporting of locations/indices (via bitmap) and amplitude/phases of NZ coefficients.
Issue 2: fixed length (3 or 4 bits) encoding of amplitude of NZ coefficients. This is optimal when the amplitude distribution is uniform, i.e., probability of each amplitude value p_{i,f} is

$$x = \frac{1}{{N}_{A}}$$

where N_{A}=2^{b}^{_{A}} is a number of candidate amplitude values in the amplitude codebook C_{A}. In reality/practice, however, the amplitude distribution is non-uniform. For example, small amplitude values (close to 0) can be more likely than large values (close to 1).

One or more embodiments of this disclosure provide examples to address Issue 1 and Issue 2 described herein.

In one or more embodiments described herein, the bitmap and amplitude values are encoding jointly (hence reported via one joint UCI parameter), in particular, an amplitude value p_{i,f}=0 indicates a zero coefficient and an amplitude value p_{i,f}>0 indicates both index and amplitude value of a NZ coefficient. Additionally, for amplitude reporting, a variable length (VL) and lossless encoding is used. In one example, the encoding corresponds to Huffman encoding. In one example, the encoding corresponds to arithmetic coding.

The idea of a VL and lossless encoding is to assign a smaller number of bits to more probable amplitude values and a larger number of bits to less probable amplitude values. The number of VL codes, say N_{VL}, may or may not be a power of 2. For example, N_{VL} is a power of 2 for Huffman encoding. In one example, N_{VL} E S, where S={4,8,16,32} or {4,8,16} or {4,8} or {8,16} or {8,16,32}. In one example, N_{VL} is fixed (e.g., 4 or 8 or 16 or 32). In one example, N_{VL} is configured (e.g., RRC and/or MAC CE and/or DCI). In one example, N_{VL} is learnt based on the AIL-based or deep-learning-based approach.

The VL encoder is given by a set {(νₖ, Aₖ, qₖ)} or {(νₖ, Aₖ)} where k=1, . . . , N_{VL} or k=0, . . . , N_{VL}−1. Here, νₖ, Aₖ, and qₖ respectively are the VL code, amplitude value, and probability associated with the k-th code. Note that

$${q}_{k} > 0 and {\sum }_{k = 0}^{{N}_{VL} - 1} {q}_{k} = 1 .$$

Two examples are shown in Table 4 for Huffman encoding (which is based on binary {0,1} alphabet).
Value A₀=0 has the highest probability, and is assigned a VL code ν₀=0.
Value

$${A}_{1} = \frac{1}{64} ( Ex 1 ) or \frac{1}{8} ( Ex 2 )$$

has the second highest probability, and is hence assigned a VL code ν₁=10.
Value

$${A}_{2} = \frac{1}{32} ( Ex 1 ) or \frac{1}{4 \sqrt{2}} ( Ex 2 )$$

has the second highest probability, and is hence assigned a VL code ν₂=110.
And so on.

TABLE 4

| | Amplitude value | Amplitude value | |
|---|---|---|---|
| VL code vₖ | Aₖ: Ex 1 | Aₖ: Ex 2 | Probability qₖ |
| 0 | 0 (zero coefficient) | 0 (zero coefficient) | 1/2 |
| 10 | 1/64 | 1/8 | 1/4 |
| 110 | 1/32 | $\frac{1}{4 \sqrt{2}}$ | 1/8 |
| 1110 | 1/16 | 1/4 | 1/16 |
| 11110 | 1/8 | $\frac{1}{2 \sqrt{2}}$ | 1/32 |
| 111110 | 1/4 | 1/2 | 1/64 |
| 1111110 | 1/2 | $\frac{1}{\sqrt{2}}$ | 1/128 |
| 1111111 | 1 | 1 | 1/256 |

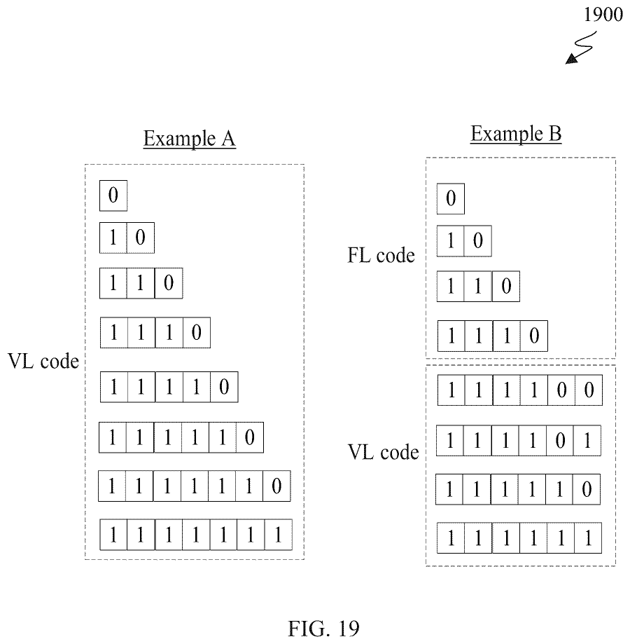

FIG. 19 illustrates an example of codes of a VL encoder 1900 according to embodiments of the present disclosure. This example is for illustration only and other embodiments can be used without departing from the scope of the present disclosure.

In one example, the all codes of a VL encoder has different code lengths (cf. Example A of FIG. 19). In one example, a subset (S1) of all codes of a VL encoder has different code lengths, and the remaining (S2) codes have a same code length. An example is shown in FIG. 19 as Example B wherein there are four variable length codes and remaining four fixed length codes.

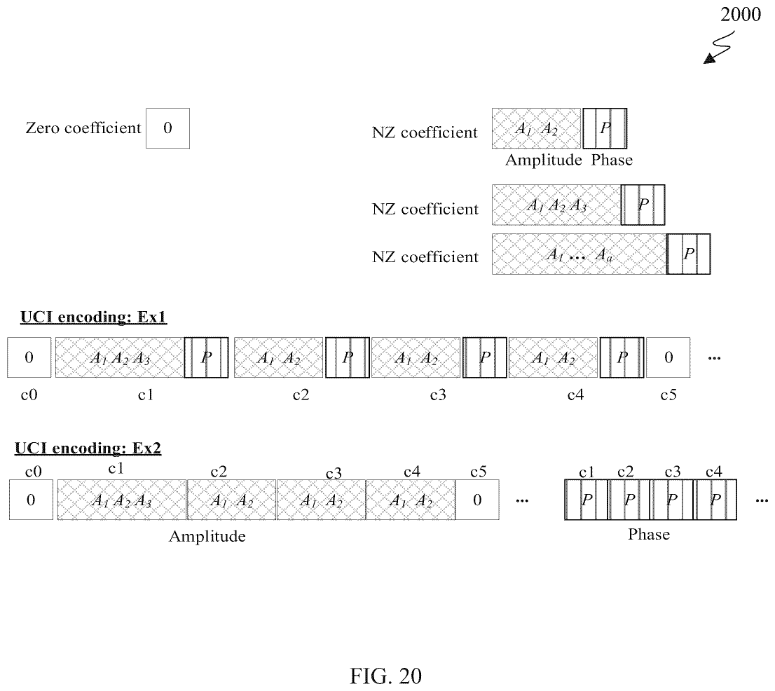

FIG. 20 illustrates an example of uplink control information 2000 according to embodiments of the present disclosure. This example is for illustration only and other embodiments can be used without departing from the scope of the present disclosure.

In one example, for UCI encoding, (amplitude, phase) of each NZ coefficient are placed (reported) together in the UCI bit sequence. An example is shown in FIG. 20 as UCI encoding Ex1.
The first coefficient c₀=0, which corresponds to the first bit in the UCI bit sequence.
The second coefficient c₁ has an amplitude p₁>1 which is indicated by a 3-bit A₁A₂A₃. The phase of this coefficient is reported via a bit sequence of P bits which is placed right after A₁A₂A₃.
The third coefficient c₂ corresponds to bit sequence A₁A₂P which is placed next.
The fourth coefficient c₃ corresponds to bit sequence A₁A₂P which is placed next.
And so on.

The final encoding sequence is given by 0A₁A₂A₃PA₁A₂PA₁A₂P0 . . . .

In one example, for UCI encoding, amplitudes of all coefficients (zero and NZ) are placed (reported) together in the UCI bit sequence. The phases of only NZ coefficients are then follows in the same order as those of reported NZ amplitudes. An example is shown in FIG. 20 as UCI encoding Ex2.

In one example, at least one of νₖ, Aₖ, qₖ is AIML-based (or deep-learning-based) and the rest are non-AIML-based.
In one example, νₖ is AIML-based (or deep-learning-based) and Aₖ, qₖ are non-AIML-based.
In one example, Aₖ is AIML-based (or deep-learning-based) and νₖ, qₖ are non-AIML-based.
In one example, qₖ is AIML-based (or deep-learning-based) and Aₖ, νₖ are non-AIML-based.
In one example, νₖ, Aₖ are AIML-based (or deep-learning-based) and qₖ is non-AIML-based.
In one example, νₖ, qₖ are AIML-based (or deep-learning-based) and Aₖ is non-AIML-based.
In one example, qₖ, Aₖ are AIML-based (or deep-learning-based) and νₖ is non-AIML-based.
In one example, νₖ, Aₖ, qₖ are AIML-based (or deep-learning-based).

In one example, at least one of νₖ, Aₖ is AIML-based (or deep-learning-based) and the other is non-AIML-based.
In one example, νₖ is AIML-based (or deep-learning-based) and Aₖ is non-AIML-based.
In one example, Aₖ is AIML-based (or deep-learning-based) and νₖ is non-AIML-based.
In one example, νₖ, Aₖ is AIML-based (or deep-learning-based).

In one example, a distribution {qₖ} over amplitude alphabet {Aₖ} is according to one of the following examples.
In one example, qₖ is a power 2. For example, Huffman encoding.
In one example, qₖ can be any value in 0<qₖ≤1. For example, arithmetic encoding.
In one example, the amplitude alphabet {Aₖ} is according to one of the following examples.
In one example, Aₖ can be any value in 0≤Aₖ≤T. Here, T is a threshold, which can be fixed, or configured (e.g., RRC) or reported by the UE (e.g., via CSI report or UE capability reporting).
In one example, Aₖ can be any value in 0≤Aₖ≤1.

In one example, an encoding {νₖ} of amplitude alphabet {Aₖ} is according to one of the following examples.
In one example, νₖ is based on (two) binary values {a₀, a₁}. For example, a₀=0, a₁=1, for Huffman encoding, and νₖ=b₁ . . . bₙ_{ₖ} where bⱼ∈{0,1}, j=1, . . . , nₖ, and nₖ is a length of the code νₖ.
In one example, νₖ is a real number between [a₀, a₁]. For example, νₖ∈[0,1] for arithmetic encoding.

At least one of the following examples can be used/configured regarding the VL encoder.
In one example, the VL encoder (as described herein) is trained/learnt or determined/configured such that it is the same/common across multiple cells (in a cellular system). That is, there is one VL encoder for all cells.
In one example, the VL encoder (as described herein) is trained/learnt or determined/configured in a cell-specific manner such that it is specific to a cell (in a cellular system) and it can change across cells. That is, there is one VL encoder for each cell. This cell-specific VL encoder can be UE-common (i.e., the same/common for all UEs connected to the respective cell).
In one example, the VL encoder (as described herein) is trained/learnt or determined/configured in a UE-specific manner such that it is specific to a UE (in a cell of a cellular system) and it can change across UEs. That is, there is one VL encoder for each UE. This UE-specific VL encoder can be UE-group-common (i.e., the same/common for a group of UEs connected to the respective cell).
   In one example, UCI part 1 of a two-part UCI provides information about the VL encoder (e.g., it can be a part of the codebook or a CSI report).
   In one example, the VL encoder is reported in a standalone manner (e.g., via a one-part UCI or part 2 of a two-part UCI).

In one or more embodiments described herein, the alphabet or set of amplitude values {Aₖ} for coefficient amplitude quantization and reporting is according to at least one of the following schemes.
In Scheme 1, the set {Aₖ} is fixed (e.g., z or 1-z where

$$z = \frac{1}{{2}^{M}} or \frac{1}{\sqrt{{2}^{M}}} or \frac{1}{{2}^{\frac{M}{s}}} or {2}^{- \frac{M}{s}} or {2}^{- \frac{1}{s} ( P - M )} ,$$

s∈{1, 2, . . . }, M∈{1, 2, . . . }, P≥M). In one example, this is regardless of the value of N_{VL}. In one example, the set {Aₖ} is fixed for a given value of N_{VL}, and the set can be change for two different values of N_{VL}.
In Scheme 2, the set {Aₖ} can be learnt (or trained) based on AIML or deep-learning approach, e.g., by UE and reported to the NW, or by NW and configured/transferred to UE. In one example, the size of the learnt alphabet, or a value of N_{VL} is fixed. In one example, the size of learnt alphabet, or a value of N_{VL} is also learnt. In one example, the size of learnt alphabet, or a value of N_{VL} is configured (if the learning is performed by the UE). In one example, the distribution {qₖ} of the learnt alphabet is fixed. In one example, the distribution {qₖ} of the learnt alphabet is also learnt. In one example, the distribution {qₖ} of the learnt alphabet is configured (if the learning is performed by the UE).
In Scheme 3, the set {Aₖ} can be configured (e.g., via RRC and/or MAC CE and/or DCI). In one example, the size of the learnt alphabet, or a value of N_{VL} is fixed. In one example, the size of learnt alphabet, or a value of N_{VL} is also learnt. In one example, the size of learnt alphabet, or a value of N_{VL} is configured (if the learning is performed by the UE). In one example, the distribution {qₖ} of the learnt alphabet is fixed. In one example, the distribution {qₖ} of the learnt alphabet is also learnt. In one example, the distribution {qₖ} of the learnt alphabet is configured (if the learning is performed by the UE).

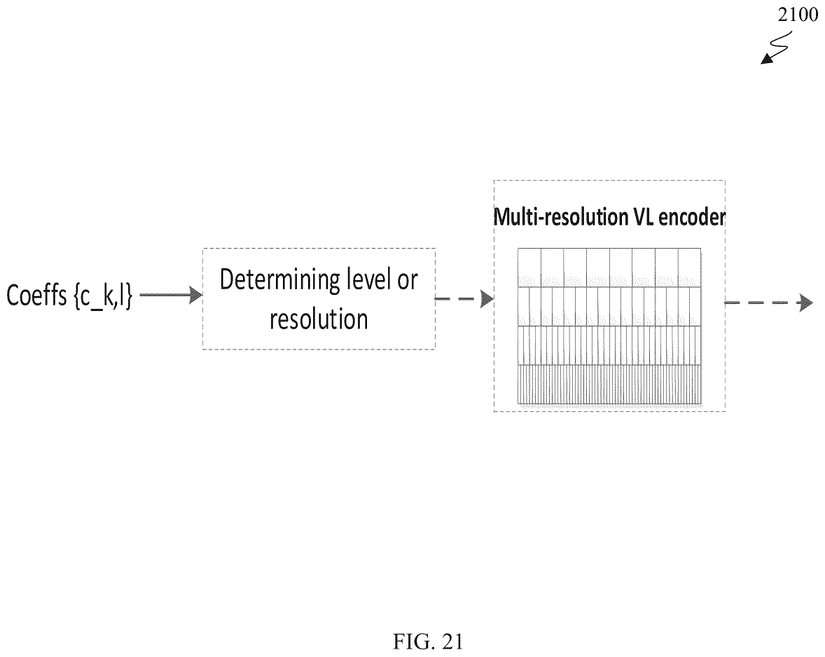

FIG. 21 illustrates a diagram of an example of a VL encoder based on a multi-level codebook 2100 according to embodiments of the present disclosure. This example is for illustration only and other embodiments can be used without departing from the scope of the present disclosure.

In one or more embodiments described herein, the VL encoder for amplitude reporting is based on a multi-level (multi-resolution) codebook, where each level corresponds to a VL encoder can be AIML-based (trained) or non-AIML-based (fixed, non-trained), as described herein. Let N_{Z} be the number of levels. In one example, a level (and corresponding VL encoder) from this multi-level codebook is selected based on the estimated or desired resolution level. In one example, the value of N_{Z} is fixed (e.g., 2), or can be learnt, or can be configured (e.g., RRC and/or MACE CE and/or DCI). Let N_{VL,z} be a number of VL codes corresponding to the VL encoder at level z∈{1, . . . , N_{Z}}. In one example, N_{VL,z}_{₁}>N_{VL,z}_{₂} for all z₁>z₂ and zᵢ∈{1, . . . , N_{Z}}. In one example, N_{VL,z}_{₁}<N_{VL,z}_{₂} for all z₁>z₂ and zᵢ∈{1, . . . , N_{Z}}. An example is shown in FIG. 21 where there are four levels, each level corresponds to a VL encoder (as described herein).
In one example, each level is independent of one another.
In one example, a level with lower resolution (smaller N_{VL,z} value) is included in at least one or all levels with higher resolution.

In one or more embodiments described herein, there can be multiple VL encoders (or codebooks) for amplitude reporting, and NW configures one or multiple VL encoders to a UE. When multiple, the UE can select and report (e.g., via CSI part 1 or UCI part 1) one of the configured VL encoders. In one example, these multiple VL encoders can correspond to independent VL encoders. In one example, these multiple VL encoders can comprise (or included in) a multi-resolution encoder as described herein. In one example, any of the multiple VL encoders can be AIML-based (trained) or non-AIML-based (fixed, non-trained).

In one example, for initial amplitude reporting, the NW can configure a fixed codebook (e.g., W1W2 based on Rel-16 enhanced Type II in 5G NR, 5.2.2.2.5 of 38.214), and the NW can then switch (trigger) to a VL encoder for amplitude reporting, or the UE can initiate (recommend) a request/trigger for the switch to a VL encoder.

In one or more embodiments described herein, a UE can be configured to receive CSI-RS and/or transmit SRS, to train/learn the VL encoder for amplitude reporting, according to at least one of the following examples.
In one example, a UE is configured to measure CSI-RS (e.g., 1 or >1 NZP CSI-RS ports) and use the measurement to train/learn the VL encoder for amplitude reporting, where the VL encoder is as described herein. The UE then reports the learnt/trained VL encoder to the NW.
In one example, a UE is configured to transmit SRS (e.g., 1 or >1 SRS ports) and NW can use the SRS measurement to train/learn the VL encoder for amplitude reporting, where the VL encoder is as described herein. The NW then shares/transfers the learnt/trained VL encoder to the UE.
In one example, a UE is configured to measure CSI-RS (e.g., 1 or >1 NZP CSI-RS ports) and use the measurement for (A) and/or (B), where
   (A) to train/learn the VL encoder for amplitude reporting, where the VL encoder is as described herein.
   (B) to transmit SRS (e.g., 1 or >1 SRS ports) and NW can use the SRS measurement to train/learn the VL encoder for amplitude reporting, where the VL encoder is as described herein.
In one example, a UE is configured to transmit SRS (e.g., 1 or >1 SRS ports) and NW can use the SRS measurement for (A) and/or (B), where
   (A) to train/learn the VL encoder for amplitude reporting, where the VL encoder is as described above.
   (B) to transmit CSI-RS (e.g., 1 or >1 CSI-RS ports) and UE can use the CSI-RS measurement to train/learn the VL encoder for amplitude reporting, where the VL encoder is as described above.

In one or more embodiments described herein, a value of K^{NZ} (number of NZ coefficients) and a value

$$( say {A}_{VL}^{Tot} )$$

of length of the VL codes associated with these K^{NZ} coefficients (amplitudes) are determined/reported by the UE. In one example, they are determined/reported via UCI according to at least one of the following examples.
In one example, two separate parameters are used, for example, both in UCI part 1 (or CSI part 1). One parameter for

$${A}_{VL}^{Tot}$$

and another parameter for K^{NZ}. In one example, K^{NZ} determines the number of bits for phase reporting (in addition to number of NZ coefficients), and

$${A}_{VL}^{Tot}$$

determines the number of bits for amplitude reporting.
In one example, a joint UCI parameter indicates two values (one parameter for A_{VL}^{Tot} and another parameter for K^{NZ}).

In one or more embodiments described herein, K^{NZ} is not reported, and a value

$$( say B = {A}_{VL}^{Tot} + {P}^{Tot} )$$

of a sum of the length of the VL codes (for amplitudes)

$${A}_{VL}^{Tot}$$

and that of the corresponding phases P^{Tot}, that are associated with the K^{NZ} NZ coefficients is determined/reported by the UE. For each coefficient with index, say (i, f), coefficients are traversed (or arranged in UCI) in a fixed (configured) order, and for a coefficient,
if amplitude=0, the number of bits is fixed (e.g., 1), and
if amplitude>0, the number of bits=Nₐₘₚ+Nₚₕ, where Nₐₘₚ depends to the VL encoder for amplitude, and Nₚₕ can be fixed (e.g., 3 or 4 or bits for 2^{N}-PSK phase) or can depend to the VL encoder for phase (if used).

In one or more embodiments described herein, the phase values of the N_{Z} coefficients are reported based on a VL phase encoder, where the VL phase encoder is similar to of the VL encoder described above for amplitude reporting, expect that the amplitude values {Aₖ} are replaced with phase values {Pₖ}, where

$${P}_{k} ∈ \{ {α}_{m} = {e}^{j {θ}_{m}} \} or \{ {α}_{m} = {e}^{\frac{j 2 π {y}_{m}}{Y}} \} where {θ}_{m} ∈ [ 0 , 2 π ] or [ - π , π ] , and$$

$${y}_{m} ∈ \{ 0 , 1 , … , Y - 1 \} or ∈ \{ - \frac{Y}{2} , - \frac{Y}{2} + 1 , … - 1 , 0 , 1 , … , \frac{Y}{2} - 1 \} .$$

In one or more embodiments described herein, the real and imaginary parts of a coefficient c can be expressed as (cᵣₑₐₗ, C_{imag}).
In one example, two separate encoders are used for reporting {Cᵣₑₐₗ} and {c_{imag}} of all NZ coefficients, respectively.
In one example, one (joint) encoder is used for reporting both {Cᵣₑₐₗ} and {C_{imag}} of all NZ coefficients.

The encoder for reporting {Cᵣₑₐₗ} and {c_{imag}} can be a VL encoder, as described in this disclosure.

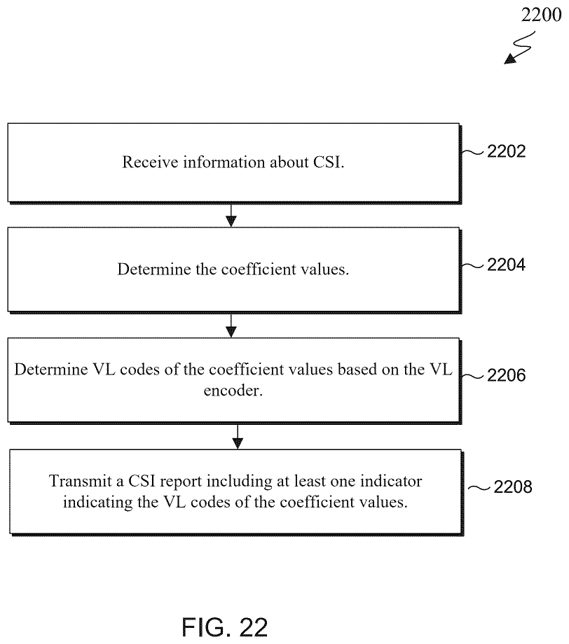

FIG. 22 illustrates an example method 2200 performed by a UE in a wireless communication system according to embodiments of the present disclosure. The method 2200 of FIG. 22 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2200 is for illustration only and other embodiments can be used without departing from the scope of the present disclosure.

The method begins with the UE receiving information about CSI (2202). For example, in 2202, the CSI includes coefficient values that are encoded based on a VL encoder {(νₖ, Aₖ)} where a coefficient value Aₖ is encoded as a VL code νₖ, k=0, . . . , N_{VL}−1, and N_{VL} is a number of VL codes. In various embodiments, the coefficient values correspond to amplitudes.

The UE then determines the coefficient values (2204). In various embodiments, the coefficient values are included into UCI as a sequence u₀u₁ . . . , where when a k-th coefficient value is zero, uₖ=νₖ=0, and when the k-th coefficient value is non-zero, uₖ includes νₖ=1b₁ . . . bₙ_{ₖ}₋₁ where nₖ is a length of the VL code νₖ, bⱼ ∈{0,1}, j=1, . . . , nₖ−1. In various embodiments, when the k-th coefficient value is non-zero, uₖ=νₖpₖ and pₖ is a bit sequence indicating a corresponding phase value. In various embodiments, the coefficient values are included into UCI as two consecutive sequences X and Y, where X is a sequence of VL codes of coefficient amplitudes, and Y is a bit sequence indicating corresponding phase values.

The UE then determines VL codes of the coefficient values based on the VL encoder (2206). In various embodiments, the VL code νₖ is a real number between 0 and 1, and the VL encoder is based on an AIML algorithm.

The UE then transmits a CSI report including at least one indicator indicating the VL codes of the coefficient values (2208). In various embodiments, the VL codes are partitioned into two parts, a first part including a subset of the VL codes that have unequal lengths, and a second part including remaining of the VL codes that have equal lengths.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive information about channel state information (CSI), the CSI including coefficient values that are encoded based on a variable-length (VL) encoder {(νₖ, Aₖ)} where a coefficient value Aₖ is encoded as a VL code νₖ, k=0, . . . , N_{VL}−1, and N_{VL} is a number of VL codes; and
a processor operably coupled to the transceiver, the processor configured to:
determine the coefficient values, and
determine VL codes of the coefficient values based on the VL encoder,
wherein the transceiver is configured to transmit a CSI report including at least one indicator indicating the VL codes of the coefficient values.

2. The UE of claim 1, wherein the coefficient values correspond to amplitudes.

3. The UE of claim 1, wherein the VL codes are partitioned into two parts, a first part including a subset of the VL codes that have unequal lengths, and a second part including remaining of the VL codes that have equal lengths.

4. The UE of claim 1, wherein:
the coefficient values are included into uplink control information (UCI) as a sequence u₀u₁ . . . , where
when a k-th coefficient value is zero, uₖ=νₖ=0, and
when the k-th coefficient value is non-zero, uₖ includes νₖ=1b₁ . . . bₙ_{_{k−1}} where nₖ is a length of the VL code νₖ, bⱼ∈{0,1}, j=1, . . . , nₖ−1.

5. The UE of claim 4, wherein, when the k-th coefficient value is non-zero, uₖ=νₖpₖ and pₖ is a bit sequence indicating a corresponding phase value.

6. The UE of claim 1, wherein the coefficient values are included into uplink control information (UCI) as two consecutive sequences X and Y, where X is a sequence of VL codes of coefficient amplitudes, and Y is a bit sequence indicating corresponding phase values.

7. The UE of claim 1, wherein:
the VL code νₖ is a real number between 0 and 1, and
the VL encoder is based on an artificial intelligence machine learning (AIML) algorithm.

8. A base station (BS), comprising:
a processor; and
a transceiver operably coupled to the processor, the transceiver configured to:
transmit information about channel state information (CSI), the CSI including coefficient values that are encoded based on a variable-length (VL) encoder {(νₖ, Aₖ)} where a coefficient value Aₖ is encoded as a VL code νₖ, k=0, . . . , N_{VL}−1, and N_{VL} is a number of VL codes; and
receive a CSI report including at least one indicator indicating VL codes of the coefficient values, wherein the VL codes of the coefficient values are based on the VL encoder.

9. The BS of claim 8, wherein the coefficient values correspond to amplitudes.

10. The BS of claim 8, wherein the VL codes are partitioned into two parts, a first part including a subset of the VL codes that have unequal lengths, and a second part including remaining of the VL codes that have equal lengths.

11. The BS of claim 8, wherein:
the coefficient values are included into uplink control information (UCI) as a sequence u₀u₁ . . . , where
when a k-th coefficient value is zero, uₖ=νₖ=0, and
when the k-th coefficient value is non-zero, uₖ includes νₖ=1b₁ . . . bₙ_{ₖ}₋₁ where nₖ is a length of the VL code νₖ, bⱼ∈{0,1}, j=1, . . . , nₖ−1.

12. The BS of claim 11, wherein, when the k-th coefficient value is non-zero, uₖ=νₖpₖ and pₖ is a bit sequence indicating a corresponding phase value.

13. The BS of claim 8, wherein the coefficient values are included into uplink control information (UCI) as two consecutive sequences X and Y, where X is a sequence of VL codes of coefficient amplitudes, and Y is a bit sequence indicating corresponding phase values.

14. The BS of claim 8, wherein:
the VL code νₖ is a real number between 0 and 1, and
the VL encoder is based on an artificial intelligence machine learning (AIML) algorithm.

15. A method performed by a user equipment (UE), the method comprising:
receiving information about channel state information (CSI), the CSI including coefficient values that are encoded based on a variable-length (VL) encoder {(νₖ, Aₖ)} where a coefficient value Aₖ is encoded as a VL code νₖ, k=0, . . . , N_{VL}−1, and N_{VL} is a number of VL codes;
determining the coefficient values;
determining VL codes of the coefficient values based on the VL encoder; and
transmitting a CSI report including at least one indicator indicating the VL codes of the coefficient values.

16. The method of claim 15, wherein the coefficient values correspond to amplitudes.

17. The method of claim 15, wherein the VL codes are partitioned into two parts, a first part including a subset of the VL codes that have unequal lengths, and a second part including remaining of the VL codes that have equal lengths.

18. The method of claim 15, wherein:
the coefficient values are included into uplink control information (UCI) as a sequence uoui . . . , where
when a k-th coefficient value is zero, uₖ=νₖ=0, and
when the k-th coefficient value is non-zero, uₖ includes νₖ=1b₁ . . . bₙ_{ₖ}₋₁ where nₖ is a length of the VL code νₖ, bⱼ∈{0,1}, j=1, . . . , nₖ−1.

19. The method of claim 18, wherein, when the k-th coefficient value is non-zero, uₖ=νₖpₖ and pₖ is a bit sequence indicating a corresponding phase value.

20. The method of claim 15, wherein the coefficient values are included into uplink control information (UCI) as two consecutive sequences X and Y, where X is a sequence of VL codes of coefficient amplitudes, and Y is a bit sequence indicating corresponding phase values.
